SEQUENCE LISTING (6 sequences)

SEQ ID NO: 1 - DNA, 10 bp, Artificial Sequence
  modified_base (1)..(1): Chol-TEG-G
gcgagtttcg

SEQ ID NO: 2 - DNA, 10 bp, Artificial Sequence
  modified_base (1)..(1): Chol-TEG-G
gcgagtttcg

SEQ ID NO: 3 - DNA, 20 bp, Artificial Sequence
  Description of Artificial Sequence Synthetic oligonucleotide
gccagtttcgtctaagcacg

SEQ ID NO: 4 - DNA, 20 bp, Artificial Sequence
  Description of Artificial Sequence Synthetic oligonucleotide
gccagtttcgtctaagcacg

SEQ ID NO: 5 - DNA, 10 bp, Artificial Sequence
  Description of Artificial Sequence Synthetic oligonucleotide
cgaaactcgc

SEQ ID NO: 6 - DNA, 20 bp, Artificial Sequence
  Description of Artificial Sequence Synthetic oligonucleotide
cgtgcttagacgaaactggc

(19) United States
(12) Patent Application Publication
(10) Pub. No.: US 2009/0274579 A1
(43) Pub. Date: Nov. 5, 2009

(54) Methods and devices for controlled monolayer formation

(76) Inventors: Owe Orwar, Hovas (SE); Aldo Jesorka, Goteborg (SE); IIja Czolkos, Goteborg (SE); Yavuz Erkan, Goteborg (SE)

Correspondence Address: Edwards Angell Palmer Dodge LLP, P.O. Box 55874, Boston, MA, 02205, US

(21) Appl. No.: 12/079,422

(22) Filed: Mar. 26, 2008

Related U.S. Application Data
(60) Provisional application No. 60/908,072, filed on Mar. 26, 2007.

(51) Int. Cl. B01L 3/00; B05D 3/00

(52) U.S. Cl. 422/99; 427/2.13

(57) ABSTRACT

Disclosed herein are methods and devices for the formation of a monolayers comprising, for example, one or several phospholipids or cholesterol-conjugated nucleic acids. The monolayers are on or associated, for example, with a surface comprising a hydrophobic material.

### RELATED APPLICATIONS

This application claims the benefit of U.S. Provisional Application No. 60/908,872, filed Mar. 26, 2007, the entire contents of which are expressly incorporated herein by reference.

### BACKGROUND

Polymers, biomaterials, and other soft materials are of ever increasing importance, both from fundamental and applied viewpoints. Applications of the materials range from the nanoscopic (e.g., biomolecular material and copolymeric mesophases) to the microscopic (microelectronics) to the macroscopic (high performance structural composites). Closely connected to the development of materials is the miniaturization of the applications, leading to ultra-small devices e.g., biomedical micromachines with molecular-level chemical sensing for non-invasive in vivo diagnostic, as well as chemical and electrochemical treatments. To achieve this miniaturization, self-assembly methods are exploited and developed leading to highly controlled methods of producing nanoscale structures and components. At this point there have only been unsuccessful attempts to develop microchannels and patterned surfaces for use with self-assemble biomolecules (e.g., lipids, polypeptides, DNA, and biopolymers) on micro- and nanostructured surfaces. Highly oriented and variable-dimension, the self-assemblies are used as templates for the processing of nano- and microscale inorganic/organic structures; for example, nanowires and nanoconduits. There is a rapidly increasing demand for biocompatible materials in, for example, medical implants and in vivo drug-delivery systems.

Moreover, to obtain insights into the functional and physiological aspects of biological membranes, chemical and dynamic properties of supported lipid mono-, bi- and multilayer membranes need to be investigated and existing tools are inadequate. It would be advantagous to have a system and method that took advantage of solid surface-associated planar membranes because of the ability to apply surface-sensitive techniques such as evanescent field spectroscopy (Watts, T., H. Gaub, and H. McConnell, 1986. Nature, 320:179-181). So far, most of the available studies on phospholipid membranes have been carried out using static lipid layers prepared by the Langmuir-Blodgett method or by vesicle-fusion, which lack control over the assembly and molecular organization process.

Most of the contemporary immobilisation techniques involve long incubation periods, several rinsing steps and harsh chemical treatment steps that make the applicability of the immobilisation system complicated and tedious. Thus, there is a need in the art for methods and techniques to immoblize biomolecules to surfaces.

### SUMMARY

Disclosed herein are methods and devices for the formation of monolayer films on solid substrates. More specifically, the invention relates to nanotechnology and nanobiotechnology and solid state—soft matter interfaces.

Described herein are methods and techniques to control molecular self-assembly of amphiphilic molecules or molecules generally comprising at least one hydrophobic part to create defined interfaces between solid state surfaces with predominantly hydrophobic characteristics and self-assembled or adsorbed molecular monolayers of defined composition. For example, the monolayers may comprise one or several phospholipids, DNA, peptides, proteins including membrane proteins, liquid crystals or mixtures thereof.

The methods and systems presented herein are applicable in many areas and fields that employ methods relying on self-assembly or self-association, for example, in biomembrane research, but also in drug screening, biomacromolecule separation and biosensing including SPR and QCM. Thus, the geometry of the device can be designed and customised for promoting specific functionalities that can be exploited for e.g., separation, reaction, and mixing phenomena in a thin film. As further examples, the methods and systems presented herein can be used for surface-assisted (2-dimensional) supramolecular and macromolecular assembly and synthesis as well as for production of nanoscale structures, and devices. In general, it forms the basis for a two-dimensional microfluidics or thin-film fluidics platform.

Disclosed herein, according to one aspect are devices comprising a substrate comprising a hydrophobic surface, wherein the hydrophobic surface is adapted for oriented association or attachment and/or oriented spreading of molecules having at least one hydrophobic part.

In one embodiment, the hydrophobic surface comprises or forms all or a part of a chamber, column, 2-dimensional surface (e.g., 96, 384, or 1536-well microtiter plates, Quartz Crystal Microbalance (QCM) crystals, Surface Plasmon Resonance (SPR), chip, microscope cover slip, microfluidic chip, sandwich cell, or channel (e.g., and/or any other geometrical configuration from nanometer to meter dimensions).

In another embodiment, the hydrophobic surface comprises one or more of SU-8, hardbaked SU-8, hydrophobic polymer, glass, ceramic, metal, or liquid crystal. (other materials having SU-8 like properties, or a material having a high contact angle with water).

In one embodiment, the hydrophobic surface comprises a pattern of substructures.

In another embodiment, the substructures comprise one or more of perforations in the layer, wells in the layer, pillars or other materials on the layer, patches, or immobilized particles, films, chemicals, or molecules.

In one embodiment, the perforations in the layer, wells in the layer, pillars or other materials on the layer, patches, or immobilized particles, films, chemicals, or molecules comprise a catalytic, binding, chemisorptive, physiosorptive, (or otherwise reactive), or modulatory effect on materials or compounds present in the thin film, a surrounding solution and/or surrounding air, gas, or vacuum.

In another embodiment, the substructures are arranged in one or more of an ordered (e.g., arrayed) or unordered manner, and are adapted to be either fully or partially covered, or to be surrounded by a spreading film of molecules having at least one hydrophobic part.

In another embodiment, the hydrophobic surface is adapted for processes comprising chemical reactions, surface-assisted synthetic procedures, catalytic processes, supramolecular self-assembly, or affinity-based separation (e.g., between materials or reactants immobilized on or within the substructures and active constituents of the spreading film can be realized).

In one embodiment, the molecules having at least one hydrophobic part comprise one or more of phospholipids, amphiphilic molecules (e.g., detergents) surfactants, proteins (e.g., membrane proteins, proteins modified with hydrophobic moieties), peptides (e.g., long or short peptides, peptides modified with hydrophobic moieties), nucleic acid, oligonucleotides (e.g., DNA, RNA, and siRNA), molecules modified with hydrophobic moieties (e.g., lipid tails all of above with the capability to form strong hydrophobic interaction with the hydrophobic surfaces).

In one embodiment, the molecules having at least one hydrophobic part comprise a film.

In another embodiment, the film comprises one or more of a liquid, solid, liquid crystal, or gel.

In one embodiment, the device further comprises a temperature controller.

In one embodiment, the temperature controller allows control such that phase transitions and spreading behavior of molecules having at least one hydrophobic part are controllable.

In one embodiment, the hydrophobic surface comprises one or more of an embossed or imprinted geometric pattern (e.g., 2D and 3D).

Disclosed herein, according to one aspect are devices comprising a substrate comprising hydrophobic surface, a less hydrophobic surface, and a film of molecules having at least one hydrophobic part at least partially covering and confined to the hydrophobic surface.

Disclosed herein, according to one aspect are devices comprising a substrate comprising a hydrophobic surface having a thin-film monolayer surface formed in a polar (e.g. aqueous) environment associated therewith, wherein the thin-film monolayer surface is formed by placing a phospholipid liposome on the hydrophobic surface, wherein the phospholipid liposome spreads to form the thin-film monolayer surface when placed on the hydrophobic surface.

In another embodiment, the thin-film monolayer further comprises one or more additional components.

In one embodiment, the further components comprise one or more of other lipids, membrane proteins, molecules or particles that are adapted to partition into membranes (e.g., drugs and dyes), or molecules and particles that are conjugated to another molecule that are adapted to partition into membranes.

In another embodiment, the one or more additional components comprise an oligonucleotide (e.g., DNA) conjugated with a hydrophobic moiety (e.g., cholesterol).

Disclosed herein, according to one aspect are devices comprising a substrate comprising a mixer comprising a first and a second injection pod in communication with a mixing region wherein the injection pods, first and second communication regions and the mixing region comprise a hydrophobic surface adapted for oriented association or attachment and/or oriented spreading of molecules having at least one hydrophobic part.

In one embodiment, the substrate further comprises one or more additional injection pods in communication with the mixing region.

In one embodiment, the substrate further comprises a less hydrophobic surface surrounding the hydrophobic surfaces.

In another embodiment, the substrate comprises gold-coated glass with patterned SU-8 (hydrophobic surface) and Ti/Au (less hydrophobic) surfaces.

In one embodiment, the device further comprises one or more additional mixers.

In one embodiment, the device further comprises input and waste channels in communication with the mixing region as well as channels to reactors (e.g. catalytic reactors and detectors). (e.g fluorescence or electrochemical detectors)

In another embodiment, the injection port is circular, square, pentagonal, hexagonal, triangular, rectangular or any other geometric shape.

In another embodiment, the mixing region is rhomboid, triangular, rectangular, hexagonal, pentagonal, circular, or any other geometric shape.

In one embodiment, the device is used for drug screening, for sensor applications, for QCM applications, for SPR applications, for evanescent wave fluorescence applications, for catalysis, for assembly of molecules (e.g., molecular synthesis or device synthesis), or for formation of molecularly thin layers or films made out of the molecules having at least one hydrophobic part.

In another embodiment, the device further comprises a sample injection port.

In one embodiment, the device further comprises a detector.

In one embodiment, the detector comprises one or more of mass spectrometry, surface plasmon resonance (SPR), quartz crystal microbalance (QCM), fluorescence detector, fluorescence correlation detector, chemiluminescence detector or electrochemical detector.

In one embodiment, the mass spectrometry used is selected from one or more of MALDI MS (MALDI-TOF and MALDI-TOF-TOF) or Electrospray Ionization (ESI MS-MS).

In one embodiment, the device further comprises one or more of a sample separator, fractionator, or manipulator.

In another embodiment, the separator is selected from one or more of Capillary Electrophoresis (CE), Liquid Chromatography (LC), gel-chromatography and gel-electrophoresis separators.

Disclosed herein, according to one aspect are methods of mixing liposomes on a surface comprising placing a first liposome (of a certain composition) on a hydrophobic surface, and placing a second liposome of a different composition on the hydrophobic surface, wherein the first and second liposomes spread and mix on the hydrophobic surface.

In one embodiment, an amount of material donated from the first and second liposomes is controlled by one or more of a size of the first and second liposomes or by timing.

In one embodiment, the method further comprises withdrawing at least part of one or both the first and second liposomes. (e.g., after they have donated the desired amount of lipids to the surface)

In one embodiment, the liposomes are placed on the hydrophobic surface with one or more of a micropipette, optical tweezer, or microfluidic device.

In another embodiment, stoichiometrical control of a film formed from the first and second liposomes is obtained.

In another embodiment, a functional surface is created by the mixing of the spreading mononlayers of first and second liposomes.

In one embodiment, the functional surface comprises one or more of a 2- or 3-dimensional device.

In another embodiment, the 2- or 3-dimensional device comprises a chamber, capillary, column or any other device of macroscopic or microscopic dimensions.

In another embodiment, the functional surface comprises one or more of a catalytic surface, a binding surface, or a surface supporting a physical or chemical operation.

In another embodiment, the hydrophobic surface comprises an array of hydrophobic surfaces and less hydrophobic surfaces.

In another embodiment, the method creates arrays of surfaces of macroscopic or microscopic dimensions.

In one embodiment, the first liposome spreads to form a first film and functionalizing (or altering) the first film by adding other molecules that bind or react with the film (e.g., in such a way that the film changes its properties).

In another embodiment, the liposomes form supramolecular structures, nanostructures, nucleic acid arrays, protein arrays, arrays of other molecular entities, particle arrays.

In one embodiment, one or more of the first or second liposomes comprise oligonucleotides, an oligonucleotide conjugated with a hydrophobic moiety, membrane proteins, molecules or particles that are adapted to partition into membranes, or molecules and particles that are conjugated to another molecule that are adapted to partition into membranes

In one embodiment, the method further comprises contacting the substrate with a sample to be detected.

In one embodiment, the sample comprises a nucleic acid or other site-directed molecular recognition molecules (e.g., proteins, antibodies or fragments thereof, or lectin), an enzyme, an inhibitor, a binding partner, or a substrate.

In one embodiment, the method further comprises one or more of chemically or physically modifying the film.

In another embodiment, different steps of chemical or physical modulations or manipulations or different steps of detection are carried out in parallel on the same sample.

In one embodiment, different steps of chemical or physical modulations or manipulations or different steps of detection are carried out in parallel on different samples.

In one embodiment, the method further comprises drying a film formed from the first and second liposomes.

In another embodiment, the film comprises one or more of a nucleic acid film or a protein film.

In one embodiment, the method further comprises drying the nucleic acid film is dried on the surface of the substrate.

In one embodiment, the method further comprises storing the nucleic acid film dry.

In one embodiment, the method further comprises rehydrating the film.

In one embodiment, the method further comprises detecting an interaction between the film and the sample.

Disclosed herein, according to one aspect are methods of dynamic liquid film formation comprising suspending a multilamellar vesicle in buffer, and placing the vesicle on a substrate comprising a hydrophobic surface, whereby the vesicle spreads as a monolayer on the surface.

In one embodiment, the method further comprises placing a second multilamellar vesicle on the substrate, whereby the vesicle and the second vesicle spread and mix.

In one embodiment, the method further comprises placing a third multilamellar vesicle on the substrate, whereby the vesicle, the second vesicle, and the third vesicle spread and mix.

In one embodiment, the substrate comprises a device of claim 17.1.

In another embodiment, the coefficient of spreading comprises from between about 0.01 to about 500 μm²/s.

Disclosed herein, according to one aspect are methods of forming a nucleic acid film, comprising placing modified nucleic acid molecules on a hydrophobic surface of a substrate, wherein the modified nucleic acid molecules associate with the surface.

In one embodiment, the modified nucleic acid molecules comprise cholesteryl-tetraethyleneglycol-modified oligonucleotides (hexaethyleneglycol/polyethyleneglycol).

In one embodiment, the method further comprises placing a second modified nucleic acid molecules on the hydrophobic surface of the substrate.

In another embodiment, the modified nucleic acid molecules comprise nucleic acids of the same or different sequence.

In one embodiment, the second modified nucleic acid molecules are placed on a second hydrophobic structure on the substrate.

In one embodiment, the method further comprises placing three or more modified nucleic acid molecule samples on the substrate.

In one embodiment, the samples are placed on a contiguous hydrophobic surface or on individual hydrophobic surfaces each surrounded by less hydrophobic surfaces.

In another embodiment, the individual hydrophobic surfaces comprise features sized from between about 1 nm to about 5 cm.

In one embodiment, the modified nucleic acid molecules comprise a surface coverage of from between about 10 to about 200 pmol/cm².

In one embodiment, the modified nucleic acid molecules comprise a surface coverage of from between about 20 to about 95 pmol/cm².

In another embodiment, the modified nucleic acid molecules comprise a film density of from between about 10¹² to about 10¹³ molecules/cm².

In one embodiment, the method further comprises hybridizing complementary nucleic acid to the nucleic acid film.

Other embodiments are disclosed infra.

### BRIEF DESCRIPTION OF THE FIGURES

FIG. 1A depicts a schematic of one embodiment, which is a carrier substrate (e.g., glass) coated with an adhesion layer of Ti, a base layer of gold and a top layer of a hydrophobic material (SU-8 polymer).

FIG. 1B depicts a schematic drawing of a patterned surface device. Shown is a carrier substrate (e.g., glass) coated with an adhesion layer of Ti, a base layer of gold and a microstructured top layer of a hydrophobic material (SU-8 polymer).

FIG. 1C shows a brightfield micrograph of a patterned surface device of the same general construction as depicted in FIG. 1B, comprising three different top structures with two (upper row), three (middle row) or four (lower row) separate injection areas (Ø25 μm), lanes (width 5 μm) and central mixing areas.

FIG. 1D depicts a schematic of a patterned surface with anchor points on a spreading lane. The anchor points are embossed or embedded and carry functional groups for chemical or physical interactions with constituents in the spreading lipid-film.

FIG. 2A shows an experimental setup, depicting the patterned device amidst components, including an inverted microscope for visualization and control; a micromanipulator for positioning of the injection needle; an injection needle; a pump for deposition of soluble or suspended materials; and chemicals such as lipids on the device, and a resistive heating device for temperature control.

FIG. 2B shows a brightfield microscope image of meandering lanes for visualization of film spreading. A phosphospholipid deposit (multilamellar vesicle, Ø 5 μm) is situated on the center injection area. Diameter of circular SU-8 structure: 25 μm.

FIG. 2C depicts a schematic of the circular spreading of a molecular film comprising an amphiphilic species with a hydrophobic tail group (e.g., a phospholipid) on the hydrophobic, planar device surface. The elevated center structure represents a lipid deposit comprising a multilamellar vesicle. Arrows indicate the isotropic direction of spreading.

FIG. 2D depicts a time series of fluorescence micrographs showing spreading of a phospholipid film on a planar structured SU-8 device depicted in FIG. 2B; Panel (i): 19 min after deposition, panel (ii): 30 min after deposition, panel (iii): 208 min after deposition, panel (iv): 499 min after deposition. The diameter of the circular SU-8 structure is 25 μm.

FIG. 3A depicts a time series of fluorescence micrographs showing lipid mixing of two components on a device covered with SU-8 similar to FIG. 1A. Panel (i): at 4 min, panel (ii): progress after 6 min, panel (iii): after 9 min panel (iv): after 27 min. One of the two lipid fractions is fluorescently labeled (appearing brighter), the other unlabeled (appearing dark). Mixing is observed as a decrease in fluorescence of the labeled component. The diameter of the circular structure is 25 μm.

FIG. 3B depicts a time series of micrographs showing lipid mixing of three components on a device with a three lane mixing surface, as depicted in FIG. 1C. Panel (i): brightfield micrograph, immediately after deposition of phospholipids; panels (ii)-(vi) fluorescence micrographs; panel (ii): at 0 min, immediately after deposition of phospholipids; panel (iii): progress after 20 min; panel (iv): after 90 min; panel (v): after 210 min, (vi): after 240 min. The three lipid fractions deposited on the three injection areas are labeled with three differently emitting fluorescent dyes to follow their spreading simultaneously. The diameter of the circular SU-8 structures is 25 μm, the images are in inverted colors for better contrast.

FIG. 3C depicts a schematic drawing of lipid spreading and mixing on a device with a single lane surface in the presence of functional film constituents. The spreading lipid films originate from multilamellar vesicles in the center of each injection area. Panel (i): Drawing of a single-lane spreading and mixing device with two lipid components, each carrying one of two active components. Lipid spreading originates from two multilamellar vesicles situated on two injection areas interconnected with a single lane. The additive components are mobile together with the spreading lipid and react with each other upon mixing in the central area (inset) of the lane. Panel (ii): depicts a schematic of a separation device based on lipid spreading on a single-lane surface. The lipids forming the film originate from a single multilamellar vesicle in one injection area. The single lane connected to the injection area contains active functionalized surface substructures, which are depicted as encircled dots. In this embodiment two mutually unreactive components are mixed with the spreading lipid material, wherein one of the two is reactive towards the activated surface area, while the other component is unreactive. Upon spreading across the lane, the two materials reach the activated surface area in the central part (inset) of the lane. The reactive component is retained, while the inactive component continues migration, effectively separating the two constituents in this two-dimensional nanofluidic film device.

FIG. 4 shows the quantification of the mixing of two phospholipid deposits (one labelled, one unlabelled) by plotting fluorescence intensity I vs. the mole fraction Φ of the doped polar soybean lipid preparation. Except for Φ=0. and x represent independent measurements on identical structures. The measurements were carried out approximately 16 hours after application of the lipids to accomplish equal distribution of lipid across the structure. Each pair of data points is accompanied with a symbolic representation of the lipid film composition on the surface.

FIG. 5A depicts a schematic representation of a DNA immobilization and hybridization procedure on a patterned surface device. Panel (i): Solution containing cholesterol-TEG-ssDNA is pipetted manually onto the patterned SU-8/gold substrate. Panel (ii): Following an incubation period, the coverslip (e.g., surface or substrate) is rinsed, dried and re-hydrated, leaving ssDNA adsorbed only on the hydrophobic SU-8 areas. Panel (iii): Solution containing cDNA is pipetted onto the substrate. After an incubation period, to allow hybridization to occur, the coverslip (e.g., surface or substrate) is rinsed, dried and re-hydrated. Panel (iv): DNA/cDNA double strands are assembled selectively on the hydrophobic SU-8 areas.

FIG. 5B depicts a schematic representation of DNA immobilization and hybridization on the device at the molecular level. Panels (i), (ii): The fluorescently labelled (label 1, 500-600 nm emission) cholesterol-ssDNA conjugates are immobilized on the hydrophobic SU-8 structures on the device. Panels (iii), (iv): Fluorescently labelled (label 2, 550-700 nm emission) complementary ssDNA is added to the solution and hybridizes with the surface immobilized ssDNA. The double labelled dsDNA is available only on the hydrophobic SU-8 areas on the structured surface.

FIG. 5C depicts fluorescence micrographs showing the immobilisation detection of fluorescently labeled cholesterol-TEG-DNA conjugates. Panel (i): Fluorescence of DNA1 immobilized on SU-8 in buffer solution after 15 min of incubation (λ_{exc}=633 nm, λₑₘ=660-750 nm). Panel (ii): Fluorescence of DNA3 immobilized on SU-8 in buffer solution after 25 min of incubation (λ_{exc}=488 nm, λₑₘ=500-540 nm). The images are shown in false color.

FIG. 6 depicts hybridization detection by FRET using the DNA3+c-DNA3/4 probe couple. Left column represents DNA3 fluorescence (detection in the 500-540 nm em. channel, 488 nm excitation wavelength). Right column represents c-DNA3/4 fluorescence (detection in the 550-620 nm em. channel, 488 nm excitation wavelength). Panels (i), (ii): After deposition and washing away the DNA3 solution, drying and rehydrating with buffer solution. Panels (iii), (iv): Washing away buffer solution and adding c-DNA3/4 solution. Panels (v), (vi): Washing away c-DNA3/4 solution, drying and rehydrating with buffer solution. The graphs below the columns quantify intensity data for each panel i-vi.

FIG. 7 depicts a fluorescence recovery after photobleaching (FRAP) time series. Fluorescence micrographs are taken at 543 nm excitation wavelength using the 550-620 nm em. channel in buffer solution. Panel (i): DNA1+c-DNA1/2 probe couple. Before bleaching, t=0 s, t=300 s, t=600 s. Panel (ii): DNA3+c-DNA3/4 probe couple. Before bleaching, t=0 s, t=300 s, t=600 s. Panel (iii): Fluorescence recovery of bleached region vs. time for the two series. Fluorescence intensity values are normalized to 100.

FIG. 8 shows thermotropic switching of DEPE lipid spreading. (a) Transmission micrograph of an SU-8 structure with SPE lipid vesicles applied to the left and right circular pads. A DEPE particle doped with rhodamine phosphatidylethanolamine was placed on the circular pad in the middle. (b) SU-8 structures aligned to a coiled, thin Ti/Au film to which a DC current is applied and thereby the device is heated. (c-f) Overlays of fluorescence micrographs corresponding to (a). DEPE (middle) speads into a monolayer when the temperature is elevated above Tₘ (c-d). To show that spreading is stopped below Tₘ, SPE lipid doped with carbofluorescein phosphatidylethanolamine (exc 488 nm, em 500-560 nm) and SPE doped with Alexa 633 phosphatidylethanolamine (exc 633 nm, em 640-800 nm), were deposited on the left and right pad, respectively. While the SPE lipid monolayer films spread on the SU-8 structure, the DEPE spread maintains its size (exc 543 nm, em 550-650 nm) (e-f).

### DETAILED DESCRIPTION

Well-defined formation of molecular monolayers on surfaces is highly desirable to construct a variety of chemical reaction devices, sensors, or screening devices as well as other applications. Presented herein are devices with a hydrophobic surface, wherein no specific hydrophobic modification or treatment of the surface is required. The devices described herein further comprise at least one molecularly thin layer of a material covering the hydrophobic surface and methods to form such molecularly thin layers. As used herein, “molecularly thin,” includes thicknesses from between about 0.1 nm and about 1000 μm; from between about 10 nm and about 200 μm; or from between about 100 nm and about 100 μm; from between about 500 nm and about 100 μm; or any single value or subrange there between.

The spontaneous assembly and growth of lipid bilayers from a lipid-surface interface has received growing interest due to its simple and widely applicable methodology for the preparation of relatively defect-free lipid membranes (Goennenwein S. et al., Biophys. J 85:646-655 (2003); Salafsky J. et al., Biochemistry 35(47):14773-14781 (1996)). The methods disclosed herein comprise spontaneous growth of a single lipid bilayer on a solid substrate, which begin, for example, from a deposited lipid reservoir in aqueous medium. A physical model has been proposed to describe the experimentally observed behavior (Czolkos I. et al., Nano Letters 7:1980-1984 (2007)). The methods and systems presented herein allow for direct manipulation of biological macromolecules in their quasi-native environment, such as proteins and DNA, within micro- and nanofluidic systems, biosensors and other analytical tools.

One example for use of the described methods and systems herein is the incorporation of functional membrane proteins into a surface-associated membrane In the past, the effect of lipid-substrate interface properties on the self-spreading of membranes has been studied. (S. Goennenwein et al., (2003) Biophys. J. 85, 646-655). Reports on the suitability of different substrate materials, such as mica, glass, and polymer-coated glass, have appeared, showing the ability of these materials to induce bilayer self-spreading to some extent. Silicon, in particular, shows potential for diverse applications including molecular sensing or detection technologies through interfacing to electronic devices. Several other factors governing the formation and nanomechanics of lipid layers have been investigated, such as the electrolyte concentration, temperature, and electric fields. To date, however, no suitable interface has been reported that allows for controlled spreading of lipid monolayers. Thus, presented herein are methods and systems providing a suitable interface for controlling spreading of lipid monolayers.

Another example for use of the methods and systems provided herein is the exploitation of DNA for sensing applications. Many applications in biotechnology are based on DNA addressability and molecular recognition. In this context, efficient immobilization protocols yielding high surface-coverage and functional accessibility of single-stranded DNA (ssDNA) on different substrates is therefore of great importance. DNA microarrays can be produced either by lab-on-chip synthesis or by immobilisation of pre-synthesised DNA on the solid support. The former method is complex and rather unflexible for modelling different systems, while the latter method is less expensive and more preferred in research applications. Regarding this, a solid support for immobilisation aids in determining the efficiency of solid phase biochemical reactions, hence the utilisation of the microarray. In the past, DNA has been attached to various kind of substrates where either the substrate and/or the oligonucleotide are chemically modified.

Further presented herein are methods and devices for the formation of variable-dimension molecular monolayer films of controlled composition on hydrophobic surfaces, wherein no specific hydrophobic modification or treatment of the surface is required because the surface as it exists is hydrophobic. The device comprises, in one embodiment, a hydrophobic substrate that can be patterned as microstructures on e.g., hydrophilic supports. Thin molecular films comprising modified DNA (e.g. cholesteryl-conjugated DNA), lipids, proteins, including membrane proteins, liquid crystals as well as other amphiphilic molecules are formed on the hydrophobic surfaces. The stoichiometry and composition of the films can be controlled. For example, the stoichiometry and composition of the films can be controlled by controlling the amount of materials included in the liposomes from which the film is grown, by mixing the different films doped with different materials on a surface of defined area, by mixing the films from lanes of different width, by controlling the time period different films are introduced to the surface or by controlling the phase state of the film with e.g. temperature. Furthermore, a microdispensing technique for placing precursor aggregates such as liposomes onto the surfaces is also disclosed. The methods and devices disclosed herein is applicable in many areas and fields that employ methods that relying on self-assembly or self-association due to highly defined molecular interactions. Examples of such fields includes, for example, biomembrane research, drug screening, separations, fractionations, purification, biomacromolecule separation, single-molecule investigation, and biosensing such as surface plasmon resonance (SPR) spectroscopy and quartz crystal microbalance (QCM) technology.

Many applications in biotechnology and bioanalysis are based on surface-assisted DNA hybridization. Efficient immobilization protocols yielding high surface-coverage and functional accessibility of single-stranded DNA (ssDNA) on different substrates is therefore of great importance. DNA has been covalently attached to glass, silicon, fused silica, Si₃N₄, gold, SU-8, PDMS, PVA, and PMMA. In all of these cases either the substrate and/or the oligonucleotide needs to be chemically modified. DNA is located at predefined locations on the solid support either by on-chip synthesis or by immobilization of pre-synthesized DNA. On-chip synthesis offers high-density arrays but has practical limitations in terms of DNA sequence length, synthesis reliability, and affordability. Conversely, methods based on immobilization of DNA are generally simpler, cheaper, and more versatile. Most immobilization techniques involve incubation times of several hours, several rinsing steps, and harsh chemical treatments. Non-covalent surface adsorption of DNA is the simplest and easiest method to automate as activation/modification of the substrate and subsequent immobilization procedures that are tedious, expensive and time-consuming.

As used herein “array” includes, for example, (a) a solid support having one or more entities affixed to its surface at discrete loci, or (b) a plurality of solid supports, each support having one or a plurality of entities affixed to its surface at discrete loci. The arrays can contain all possible permutations of entities within the parameters of this invention. For example, the an array can be an all-lipid microarray, a microarray with a plurality of compounds, a microarray with a plurality of compounds including lipid vesicles, and the like.

Examples of lipids useful in the methods and devices follow. Other lipids may be used as determined by one of skill in the art having the benefit of this disclosure. Natural lipids include, for example, Lipid A (Detoxified Lipid A), Cholesterol, Sphingolipids (Spingosine and Derivatives such as D-erythro-Sphingosine, Sphingomyelin, Ceramides, Cerebrosides, Brain Sulfatides), Gangliosides, Sphingosine Derivatives (Glucosylceramide), Phytosphingosine and Derivatives (Phytosphingosine, D-ribo-Phytosphingosine-1-Phosphate, N-Acyl Phytosphingosine C2, N-Acyl Phytosphingosine C8, N-Acyl Phytosphingosine C18), Choline (Phosphatidylcholine, Platelet-Activation Factor), Ethanolamine (Phosphatidylethanolamine), Glycerol (Phosphatidyl-DL-glycerol), Inositol (Phosphatidylinositol, Phosphatidylinositol, Serine (Phosphatidylserine (sodium salt)), Cardiolipin, Phosphatidic Acid, Egg Derived (Egg Derivatives), Lyso (Mono Acyl) Derivatives (Lysophosphatides), Hydrogenated Phospholipids, Lipid Tissue Extracts (Brain & Egg, Escherichia Coli & Heart, Liver & Soy), and Fatty Acid Content of Tissue Derived Phosolipids (Phosphatidylcholine, Phosphatidylethanolamine).

Sphingolipids include, for example, Sphingosine (D-erythro Sphingosine, Sphingosine-1-Phosphate, N,N-Dimethylsphingosine, N,N,N,-Trimethylspingosine, Sphingosylphosphorylcholine, Sphingomyelin, Glycosylated Sphingosine), Ceramide Derivatives (Ceramids, D-erythro Cermaid-1-Phosphate, Glycosulated Ceramids), Sphinganine (Dihydrosphingosine) (Sphinganine-1-Phosphate, Sphinganine (C20), D-erythro Sphinganine, N-Acyl-Sphinganine C2, N-Acyl-Sphinganine C8, N-Acyl-Sphinganine C16, N-Acyl-Sphinganine C18, N-Acyl-Sphinganine C24, N-Acyl-Sphinganine C24:1, Glycosylated (C18) Sphingosine and Phospholipid Derivatives (Glycosylated-Sphingosine) (Sphingosine, .beta.D-Glucosyl, Sphingosine, .beta.D-Galactosyl, Sphingosine, .beta.D-Lactosyl), Glycosylated-Ceramide (D-Glucosyl-.beta.1-1′ Ceramide (C8), D-Galactosyl-.beta.1-1′ Ceramide (C8), D-Lactosyl-.beta.1-1′ Ceramide (C8), D-Glucosyl-.beta.1-1′ Ceramide (C12), D-Galactosyl-.beta.1-1′ Ceramide (C12), D-Lactosyl-.beta.1-1′ Ceramide (C12)), Glycosylated-Phosphatidylethanolamine (1,2-Dioleoyl-sn-Glycero-3-Phosphoethanolamine-N-Lactose), D-erythro (C17) Derivatives (D-erythro Sphingosine, D-erythro Sphingosine-1-phosphate), D-erythro (C20) Derivatives (D-erythro Sphingosine), and L-threo (C18) Derivatives (L-threo Spingosine, Safingol (L-threo Dihydrosphingosine)).

Synthetic Glycerol-Based Lipids include, for example, Phosphaditylcholine, Phosphatidylethanolamine, Phosphatidylserine, Phosphatidylinositol, Phosphatidic Acid, Phosphatidylglycerol, Cardiolipin, Diacylglycerides, Cholesterol, PEG Lipids, Functionalized Lipids for Conjugation, Phospholipids with Multifarious Headgroups, Lipids for pH Sensitive Liposomes, Metal Chelating Lipids, Antigenic Phospholipids, Doxyl Lipids, Fluorescent Lipids, Lyso Phospholipids, Alkyl Phosphocholine, Oxidized Lipids, Biotinylated, Ether Lipids, Plasmologen Lipids, Diphytanoyl Phospholipids, Polymerizable Lipids, Brominated Phospholipids, Fluorinated Phospholipids, Deuterated Lipids, Doxyl Lipids, Fluorescent Lipids, Enzyme Activators (DG, PS), Enzyme Inhibitors (v-CAM, Inhibitor of PKC), Bioactive Glycerol-Based Lipids (Platelet Activation Factor Lipids, Second Messenger Lipids), Lipid Metabolic Intermediates (Acyl Coenzyme A, CDP-Diacylglycerol, and VPC-G protein-coupled receptor (LPA₁/LPA₃ Receptor Antagonist, LPA Receptor Agonist, S1P₁/S1P₃ Receptor Antagonist, S1P₁/S1P₃ Receptor Agonist).

Ether Lipids include, for example, Diether Lipids (Dialkyl Phosphatidylcholine, Diphytanyl Ether Lipids), Alkyl Phosphocholine (Dodedylphosphocholine), O-Alkyl diacylphosphatidylcholinium (1,2-Diacyl-sn-Glycero-3-Phosphocholine & Derivatives), and Synthetic PAF and Derivatives (1-Alkyl-2-Acyl-Glycerol-3-Phosphocholine and Derivatives).

Polymers & Polymerizable Lipids include, for example, Diacetylene Phospholipids, mPEG Phospholipids and mPEG Ceramides (Poly(ethylene glycol)-Lipid Conjugates, mPeg 350 PE, mPEG 550 PE, mPEG 750 PE, mPEG 1000 PE, mPEG 2000 PE, mPEG 3000 PE, mPEG 5000 PE, mPEG 750 Ceramide, mPEG 2000 Ceramide, mPEG 5000 Ceramide), and Functionalized PEG Lipids.

Fluorescent Lipids include, for example, Fatty Acid Labeled Lipids that are Glycerol Based (Phosphatidylcholine, Phosphatidic Acid, Phosphatidylethanolamine, Phosphatidylglycerol, Phosphatidylserine) and Sphingosine Based (Sphingosine, Sphingosine-1-Phosphate, Ceramide, Sphingomyelin, Phytosphingosine, Galactosyl Cerebroside), Headgroup Labeled Lipids (Phosphatidylethanolamine, Phosphatidylethanolamine, Dioleoyl Phosphatidylethanolamine, Alexa Fluor 633 Phosphatidylethanolamine, Phosphatidylserine, Phosphatidylserine), and 25-NBD Cholesterol.

Oxidized Lipids include, for example, 1-Palmitoyl-2-Azelaoyl-sn-Glycero-Phosphocholine, 1-O-Hexadecyl-2-Azeolaoyl-sn-Glycero-3-Phosphocholine, 1-Palmitoyl-2-Glutaroly-sn-Glycero-3-Phosphocholine, 1-Palmitoyl-2-(9′-oxo-Nonanoyl)-sn-Glycero-3-Phosphocholine, and 1-Palmitoyl-2-(5′-oxo-Valeroyl)-sn-Glycero-3-Phosphocholine.

Lipids also include, for example, DEPE, DLPC, DMPC, DPPC, DSPC, DOPC, DMPE, DPPE, DOPE, DMPA-Na, DPPA-Na, DOPA-Na, DMPG-Na, DPPG-Na, DOPG-Na, DMPS-Na, DPPS-Na, DOPS-Na, DOPE-Glutaryl-Na, Tetra Myristoyl Cardiolipin (Na)₂, DPPE-mPEG-2000-Na, DPPE-mPEG-5000-Na, DPPE Carboxy PEG 2000-Na and DOTAP-Cl.

### Devices

In one aspect, disclosed herein are devices comprising a substrate comprising a hydrophobic surface, wherein the hydrophobic surface is adapted for oriented association or attachment and/or oriented spreading of molecules having at least one hydrophobic part.

Hydrophobic surfaces, as used herein, refer to surfaces or materials having a high contact angle with water. For example, contact angles may range for example, from between about 88 to about 179 degrees, from between about 90 to about 150 degrees; from between about 110 to about 130 degrees or any range or single value there between. Exemplary hydrophobic surfaces, include, for example, SU-8, hard-baked SU-8, hydrophobic polymers, glasses, ceramics, metals, or liquid crystals.

The hydrophobic surface of the device may be patterned and/or have substructures of hydrophobic surfaces. For example, the hydrophobic surfaces may form an array of hydrophobic surfaces surrounded by less hydrophobic surfaces. As used herein, less hydrophobic surfaces refers to, for example, surfaces that are less hydrophobic than the hydrophobic surfaces and that do not support lipid spreading. Contact angles for the less hydrophobic surfaces may range for example, from between about 20 to about 87 degrees; from between about 25 to about 80 degrees; from between about 30 to about 70 degrees; from between about 40 to about 60 degrees or any sub-range or single value there between. The patterns of hydrophobic surfaces may be of any shape, may be of a functional design (e.g., the mixer design described herein to facilitate the mixing of the lipid monolayers).

The hydrophobic surface may, for example, be patterned functionally, for example, to provide sites for application or placing of molecules and for mixing of molecules. For example, the substrate may comprise a mixer comprising a first and a second injection pad in communication with a mixing region wherein the injection areas, first and second communication regions and the mixing region comprise a hydrophobic surface adapted for oriented association or attachment and/or oriented spreading of molecules having at least one hydrophobic part. Substrates may further comprise one or more additional injection areas in communication with the mixing region. In other embodiments, the substrates may further comprise one or more additional mixers. The mixers may be patterned in an array format or may be randomly arrayed on the surface of the substrate. Injection ports of the substrate may be, for example, circular, square, pentagonal, hexagonal, triangular, rectangular or any other geometric shape. The mixing region may be, for example, rhomboid, triangular, rectangular, hexagonal, pentagonal, circular or any other geometric shape. The communication, e.g., channels between the injection pad and the mixing region, may be for example, from between about a few nm and about several cm long and from between about a few nm and about several cm wide; from between about 0.1 nm and about 20 cm long and from between about 0.1 nm and about 20 cm wide; from between about 10 nm and about 10 cm long and from between about 10 nm and about 10 cm wide; from between about 100 nm and about 5 cm long and from between about 100 nm and about 5 cm wide; or any sub-range or single value there between or any combination of length and width measurements. The path of the communication path may be straight, curved, serpentine, or any other shape determined appropriate by one of skill in the art for a particular purpose.

The substrates, in one embodiment, have a less hydrophobic surface surrounding the hydrophobic surfaces. The molecules having at least one hydrophobic part, for example, only spread on the hydrophobic surface and not on the less hydrophobic surface. Substrates may comprise input and waste channels in communication with the mixing region(s) as well as channels to reactors e.g. catalytic reactors and detectors e.g., fluorescence or electrochemical detectors.

Substrates may include one or more sets of passages that interconnect to form a generally closed microfluidic network. Such a microfluidic network may include one, two, or more openings at network termini, or intermediate to the network, that interface with the external world. Such openings may receive, store, and/or dispense fluid. Dispensing fluid may be directly into the microfluidic network or to sites external the microfluidic system. Such openings generally function in input and/or output mechanisms, and may include reservoirs.

Substrates also may include any other suitable features or mechanisms that contribute to fluid, reagent, and/or film manipulation or analysis. For example, substrates may include regulatory or control mechanisms that determine aspects of fluid or film flow rate and/or path. Valves and/or pumps may participate in such regulatory mechanisms. Alternatively, or in addition, substrates may include mechanisms that determine, regulate, and/or sense fluid or film temperature, pressure, flow rate, exposure to light, exposure to electric fields, magnetic field strength, and/or the like. Accordingly, substrates may include heaters, coolers, electrodes, lenses, gratings, light sources, pressure sensors, pressure transducers, microprocessors, microelectronics, and/or so on. Furthermore, each device or system may include one or more features that act as a code to identify a given device or system. The features may include any detectable shape or symbol, or set of shapes or symbols, such as black-and-white or colored barcode, a word, a number, and/or the like, that has a distinctive position, identity, and/or other property (such as optical property).

Substrates may be formed of any suitable material or combination of suitable materials. Suitable materials may include elastomers, such as polydimethylsiloxane (PDMS); plastics, such as polystyrene, polypropylene, polycarbonate, etc.; glass; ceramics; sol-gels; silicon and/or other metalloids; metals or metal oxides; biological polymers, mixtures, and/or particles, such as proteins (gelatin, polylysine, serum albumin, collagen, etc.), nucleic acids, microorganisms, etc.; and/or the like.

Substrates, also referred to as chips, may have any suitable structure. Such devices may be fabricated as a unitary structure from a single component, or as a multi-component structure of two or more components. The two or more components may have any suitable relative spatial relationship and may be attached to one another by any suitable bonding mechanism.

In some embodiments, two or more of the components may be fabricated as relatively thin layers, which may be disposed face-to-face. The relatively thin layers may have distinct thickness, based on function. For example, the thickness of some layers may be about 10 to 250 μm, 20 to 200 μm, or about 50 to 150 μm, among others. Other layers may be substantially thicker, in some cases providing mechanical strength to the system. The thicknesses of such other layers may be about 0.25 to 2 cm, 0.4 to 1.5 cm, or 0.5 to 1 cm, among others. One or more additional layers may be a substantially planar layer that functions as a substrate layer, in some cases contributing a floor portion to some or all microfluidic passages.

Components of a device described herein may be fabricated by any suitable mechanism, based on the desired application for the system and on materials used in fabrication. For example, one or more components may be molded, stamped, and/or embossed using a suitable mold. Such a mold may be formed of any suitable material by micromachining, etching, soft lithography, material deposition, cutting, and/or punching, among others. Alternatively, or in addition, components of a microfluidic system may be fabricated without a mold by etching, micromachining, cutting, punching, and/or material deposition.

Devices and parts of devices may be fabricated separately, joined, and further modified as appropriate. For example, when fabricated as distinct layers, components may be bonded, generally face-to-face. These separate components may be surface-treated, for example, with reactive chemicals to modify surface chemistry, with particle binding agents, with reagents to facilitate analysis, and/or so on. Such surface-treatment may be localized to discrete portions of the surface or may be relatively nonlocalized. In some embodiments, separate layers may be fabricated and then punched and/or cut to produce additional structure. Such punching and/or cutting may be performed before and/or after distinct components have been joined. Method of fabrication are well known to those of skill in the art.

Passages generally comprise any suitable path, channel, or duct through, over, or along which materials (e.g., fluid, particles, and/or reagents) may pass in a device system. Collectively, a set of fluidically communicating passages, generally in the form of channels, may be referred to as a microfluidic network. In some cases, passages may be described as having surfaces that form a floor, a roof, and walls. Passages may have any suitable dimensions and geometry, including width, height, length, and/or cross-sectional profile, among others, and may follow any suitable path, including linear, circular, and/or curvilinear, among others. Passages also may have any suitable surface contours, including recesses, protrusions, and/or apertures, and may have any suitable surface chemistry or permeability at any appropriate position within a channel. Suitable surface chemistry may include surface modification, by addition and/or treatment with a chemical and/or reagent, before, during, and/or after passage formation.

In some cases, passages, and particularly channels and mixing regions, may be described according to function. For example, passages may be described according to direction of material flow in a particular application, relationship to a particular reference structure, and/or type of material carried. Accordingly, passages may be inlet passages (or channels), which generally carry materials to a site, and outlet passages (or channels), which generally carry materials from a site. In addition, passages may be referred to as particle passages (or channels), reagent passages (or channels), focusing passages (or channels), perfusion passages (or channels), waste passages (or channels), and/or the like.

Passages may branch, join, and/or dead-end to form any suitable microfluidic network. Accordingly, passages may function in particle positioning, sorting, retention, treatment, detection, propagation, storage, mixing, and/or release, among others.

Reservoirs generally comprise any suitable receptacle or chamber for storing materials (e.g., fluid, particles and/or reagents), before, during, between, and/or after processing operations (e.g., measurement, treatment and/or flow). Reservoirs, also referred to as wells, may include input, intermediate, and/or output reservoirs. Input reservoirs may store materials (e.g., fluid, particles, vesicles and/or reagents) prior to inputting the materials to a portion of a substrate. By contrast, intermediate reservoirs may store materials during and/or between processing operations. Finally, output reservoirs may store materials prior to outputting from the chip, for example, to an external processor or waste, or prior to disposal of the chip.

Regulators generally comprise any suitable mechanism for generating and/or regulating movement of materials (e.g., fluid, particles, and/or reagents). Suitable regulators may include valves, pumps, and/or electrodes, among others. Regulators may operate by actively promoting flow and/or by restricting active or passive flow. Suitable functions mediated by regulators may include mixing, sorting, connection (or isolation) of fluidic networks, and/or the like.

Particles may be vesicles. Vesicles generally comprise any noncellularly derived particle that is defined by a lipid envelope. Vesicles may include any suitable components in their envelope or interior portions. Suitable components may include compounds, polymers, complexes, mixtures, aggregates, and/or particles, among others. Exemplary components may include proteins, peptides, small compounds, drug candidates, receptors, nucleic acids, ligands, and/or the like.

Suitable substrates include, for example, gold-coated glass with patterned SU-8 (hydrophobic surface) and Ti/Au (less hydrophobic) surfaces, SU-8 on glass, SU-8 on TiO₂ or SiO₂, hydrophobic SU-8 on hydrophilic SU-8, SU-8 on plastics, SU-8 on ceramics, SU-8 on rubbers as well as other SU-8-like materials (including polymers, epoxies, glasses, ceramics, rubbers, gels) in the combinations given above.

The hydrophobic surface may be a solid surface or may be a layer on another surface. For example, the hydrophobic surface may be a photoresist layer that was microfabricated on another surface. The other surface may be of a solid material or may be layered structures. For example, the substrate may be glass having a Ti/Au layer, which was applied, for example by sputtering. One of skill in the art, having the benefit of this disclosure would understand how to create substrates with hydrophobic surfaces. Patterns of hydrophobic surfaces may be created by techniques known to those skilled in the art of microchip fabrication.

The substructures of either hydrophobic material or less hydrophobic material may be, for example, perforations in the layer, wells in the layer, pillars of the same or other materials on the layer, patches, channels, wells in communication through channels, immobilized particles, immobilized molecules, or combinations thereof. The substructures may be arranged, for example, in ordered (e.g., arrayed) or unordered patterns or a combination thereof. The substructures may be adapted to be either fully or partially covered by a monolayer, or to be surrounded by a spreading film of molecules having at least one hydrophobic part. The hydrophobic surface, in addition to or as part of the substructures may have one or more of an embossed or imprinted geometric pattern (e.g., 2-D and 3-D). The substructures of hydrophobic surfaces may be surrounded by less hydrophobic surfaces. The substructures may also be of macroscopic or microscopic dimensions.

The hydrophobic surface of a substrate is adapted for processes or for carrying out processes. Such processes include, for example, chemical reactions, surface-assisted synthetic procedures, catalytic processes, supramolecular self-assembly, or affinity-based separation (e.g., between materials or reactants immobilized on or within the substructures and active constituents of the spreading film or between materials or reactants associated with one or more vesicles placed on a substrate that are subsequently or simultaneously allowed to mix).

The molecules which are able to have oriented association or attachment and/or oriented spreading on the hydrophobic surface and having at least one hydrophobic part include, for example, phospholipids, amphiphilic molecules (e.g., detergents), surfactants, proteins (e.g., membrane proteins, proteins modified with hydrophobic moieties), peptides (e.g., long or short peptides, peptides modified with hydrophobic moieties), oligonucleotides (e.g., DNA, RNA, and siRNA), molecules modified with hydrophobic moieties (e.g., lipid tails all of above with the capability to form strong hydrophobic interaction with the hydrophobic surfaces). The molecules may be associated with one another in any combination known by one of skill in the art. For example, (mono-, bi-, tri-)-cholesteryl-conjugated DNA, ferrocene-conjugated DNA, pyrene-conjugated DNA, DNA-conjugated with aromatics, DNA conjugated with lipids, Peptides and proteins conjugated with aromatic compounds such as naphthalene, and FMOC derivatives as well as lipids, and alkanes, alkenes, and alkynes. The molecules may comprise one or more additional components, including, for example, an oligonucleotide (e.g., DNA) conjugated with a hydrophobic moiety (e.g., cholesterol). The thin-film monolayer, thus, may also comprise one or more additional components. The additional components may also comprise one or more of other lipids, membrane proteins, molecules or particles that are adapted to partition into membranes (e.g., drugs and dyes), or molecules and particles that are conjugated to another molecule that are adapted to partition into membranes.

In one embodiment, the molecules having at least one hydrophobic part comprise a film. For example, either before, during or after the placing or application of the molecules to the hydrophobic surface, the molecules are or form a film. The film may be a molecularly thin film. The film may be a liquid, solid, liquid crystal, or gel or combination thereof. Films may also comprise DNA films and/or a protein films.

In one embodiment, devices described herein may further comprise a temperature controller. The temperature controller allows, for example, control over the phase transitions and spreading behavior of molecules having at least one hydrophobic part. Below the phase transition temperature the film behaves as a solid and will not spread or very slowly, and not mix or hardly mix. Above the phase transition temperature it will behave as a liquid and spread and mix. Temperature control can also be used to control the rate of reactions that take place in the thin film (Arrhenius relation).

In one aspect, provided herein are devices comprising a substrate comprising hydrophobic surface, a less hydrophobic surface, and a film of molecules having at least one hydrophobic part at least partially covering and confined to the hydrophobic surface. The molecules having at least one hydrophobic part may also completely cover the hydrophobic part. The molecules for example, form a monolayer film over the surface to partially or completely cover the surface.

In one aspect, provided herein are devices comprising a substrate comprising a hydrophobic surface having a thin-film monolayer surface formed in a polar (e.g. aqueous) environment associated therewith, wherein the thin-film monolayer surface is formed by placing a phospholipid liposome on the hydrophobic surface, wherein the phospholipid liposome spreads to form the thin-film monolayer surface when placed on the hydrophobic surface.

The devices disclosed herein, may be used, for example for 2-dimensional microfluidics, thin-film microfluidics, separations, fractionations, single-molecule studies, drug screening, for sensor applications, for QCM applications, for SPR applications, for evanescent wave fluorescence applications, for catalysis, for assembly of molecules (e.g., molecular synthesis or device synthesis), or for formation of molecularly thin layers or films made out of the molecules having at least one hydrophobic part.

In one embodiment, the covering thin film is either completely hydrophobic or at least contains one hydrophobic part in the molecule (e.g., an amphiphile). Examples of suitable hydrophobic surfaces include, for example, SU-8, in particular hard-baked SU-8 and other hydrophobic polymers, epoxies, glasses, ceramics, metals, liquid crystals, and other materials having a high contact angle with water e.g., from between about 88 to about 179 degrees, from between about 90 to about 150 degrees; from between about 110 to about 130 degrees or any sub-range or single value there between. The monolayer is formed, for example, by spreading or adsorption (or to associate by other principles) to the hydrophobic surface, e.g., by self-assembly on the surface. The formed film may be a crystal, a solid, or solid-like or it may be a liquid, a liquid-crystal or liquid-like material, for example, a phospholipids as POPC. Devices suitable to form such monolayers may comprise a partially covered hydrophobic surface, the other part being less hydrophobic in such a way that the hydrophobic film formed on the hydrophobic surface is confined to the hydrophobic parts. Thus, patterned surfaces (e.g., SU-8 on Au) can be made in one- two- or three dimensions. The device allows for the use of micromanipulation such as microinjection, and self-assembly techniques to apply and organize molecules onto the hydrophobic surface. It is also possible to combine with other techniques for material transfer and sample application such as optical traps or tweezers, and magnetic traps as well as microfluidic methods. Furthermore, devices (designed structured surfaces with double-features hydrophobic/hydrophilic) can be made to support the formation of films having controlled composition. These types of stoichiometrically-controlled films are in particular, suitable to implement with films that are mobile or spreading on the hydrophobic surface. Examples of such films are made of phospholipids.

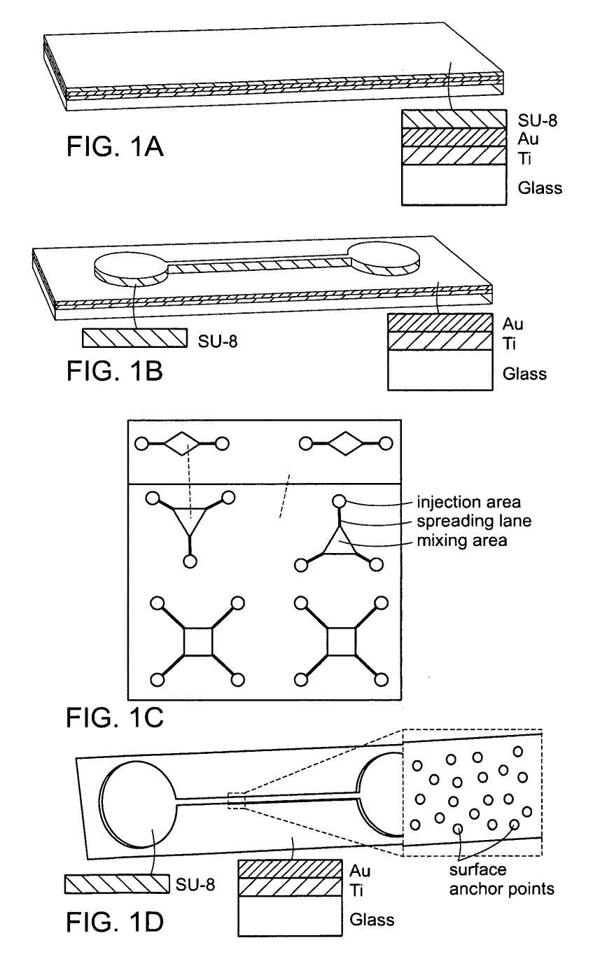

In one embodiment the device may comprise a chip surface covered (e.g., fully covered) with a hydrophobic coating such as SU-8 or hardbaked SU-8. As shown schematically in FIG. 1A, such a device may be, for example, a layered structure. Here, the epoxy-based negative photoresist SU-8 was spin-coated onto a microscope coverglass sputtered with Ti/Au. FIG. 1B is a schematic drawing showing a hydrophilic chip surface having hydrophobic features in specific patterns. Topographic structures of SU-8 were spin-coated onto microscope glass coverslips sputtered with a Ti/Au layer. FIG. 1C is a brightfield microscope image of three different types of structured devices made by SU-8 spin-coated onto microscope glass coverslips sputtered with a Ti/Au layer. The first is a mixing device for two film components, the second is a mixing device for three film components and the third is a mixing device for four film components. The device consists in part of a glass carrier substrate such as a borosilicate objective cover slip used for microscopy, coated with a thin layer of gold as hydrophilic base and thin, planar structures of the hydrophobic epoxy photoresist Michrochem SU-8. In the device shown, the planar structures cover an area of 8×12 mm on the surface of the gold-coated cover slip. This particular embodiment of the device is suitable for microscope observations, and sufficient optical transparency is maintained. The structures shown in FIG. 1C have feature sizes in the micrometer range (e.g., from about 1 to about 25 μm, from between about 5 and about 20 μm, from between about 10 and about 15 μm, from between about 12 and about 14 μm, or any sub-range or single value contained therein) and a thicknesses >20 nm (or from between about 0.01 and about 2 μm, from between about 0.1 and about 1 μm; from between about 0.5 and about 0.9 μm; or any subrange or single value contained therein). The device is fabricated, for example, under cleanroom conditions, except for the final step of hard baking to complete cross-linking of the epoxy resist, which need not be done under cleanroom conditions. However, more simple devices can be made by deposition of SU-8 to various surfaces.

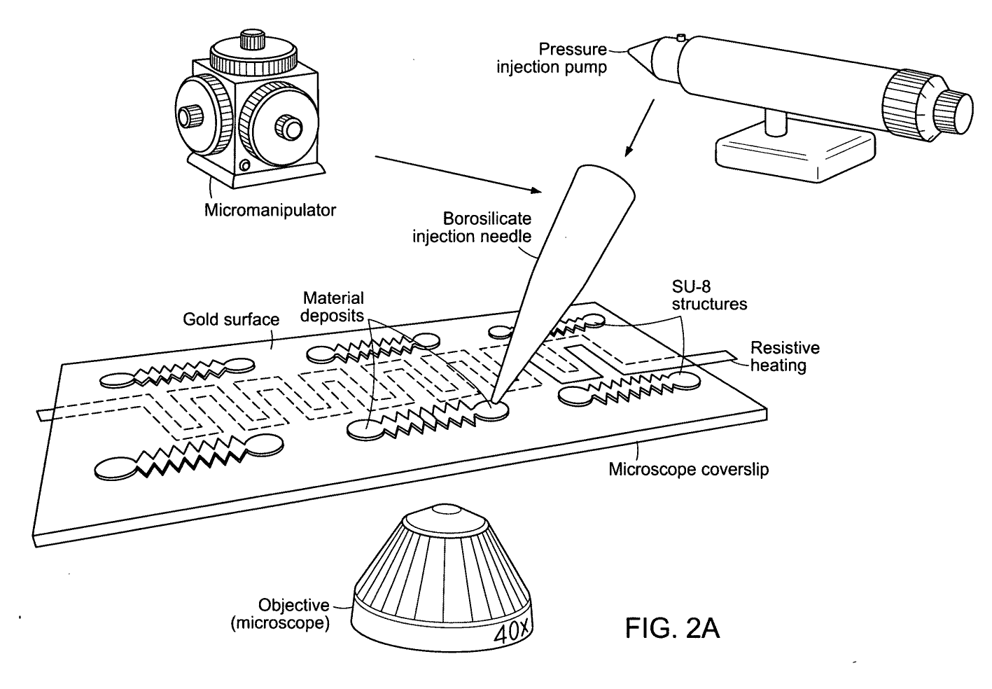

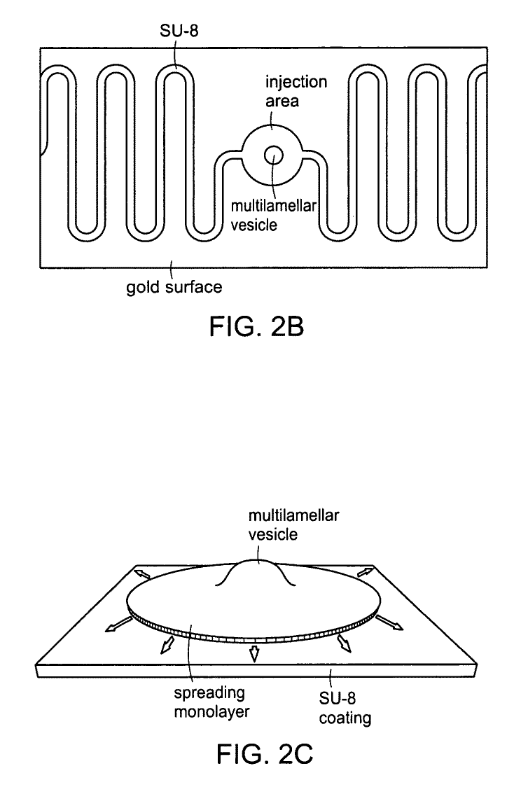

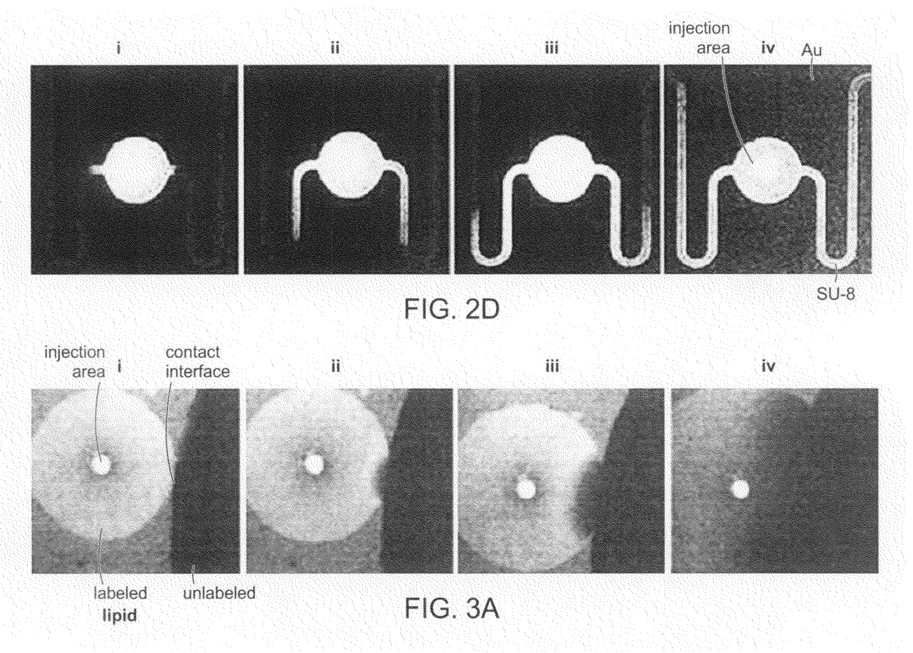

The chip devices described herein can be, for example, mounted on inverted microscopes for imaging and manipulation purposes. FIG. 2A presents one exemplary sample injection and manipulation workstation around the device that also can be automatized by robotic components. A micropipette, which is controlled by a micropositioner or manually controlled can be used to deliver material to the chip surface directly, e.g., focal injection to injection pads, or alternatively directly into the solution covering the device. Experiments may be, for example, carried out in liquid phase (e.g., a water solution) but the devices are amenable for gas phase experiments as well.

Complex sets of materials such as lipids of different structure, modified DNA (e.g. cholesteryl-conjugated DNA), proteins, including membrane proteins can be used in conjunction with the hydrophobic surface to form monolayer films or to initiate mixing or chemical reactions. When at least two different components are placed on spatially separated areas on the same hydrophobic surface, spreading and mixing can occur if the mobility of the film is sufficiently large for example, larger than about 0.01 micrometer/second on the surface. This is, for example, possible with phospholipids and other lipids. Materials of the same, closely related or different structure can in this way be brought into close proximity within touching range, mix, undergo chemical reactions (e.g., electron-transfer reactions, oxidations, reductions, and all other kinds of reactions imaginable), catalyze or inhibit chemical reactions of other constituents (e.g., such as enzymatic reactions), release material from the film (e.g., release of ssDNA from duplexes) or modify the surface in a manner that allows attachment of new material, e.g., hybridization in the case of DNA. Thus, the geometry of the device can be optimized for promoting specific functionalities that can be exploited for e.g., separation, reaction, and mixing phenomena in the thin film. As further examples this technology can be used for surface-assisted (2-dimensional) supramolecular and macromolecular assembly and synthesis as well as for production of nanoscale structures, and devices. In general, it forms the basis for a two-dimensional microfluidics platform.

FIG. 2B shows a part of a device having SU-8 patterned on a gold surface in a snake pattern radiating out from a circular injection pad. Dynamic contact angle measurements have shown that the water contact angle on SU-8 (prepared according to the procedures presented in example 1) is 91.4°±1.5° which means that it is hydrophobic, while the contact angle on gold (prepared according to the procedures presented in example 1) is 77.9°±3.2°, thus it is hydrophilic. On the circular injection pad, a multilamellar vesicle was placed using a transfer pipette controlled by a micromanipulator and a microinjector using pressure for sample application as shown in FIG. 2A. The multilamellar liposome consists of amphiphilic phospholipid molecules, featuring a hydrophobic tail group and a hydrophilic head group. As the liposome is brought to the hydrophobic SU-8 surface of the device, a monolayer film is started to form as shown schematically in FIG. 2C. The lipid only wets the SU-8 surface while the surrounding gold remains free from lipid. The hydrophobic part of the phospholipids are in contact with the SU-8 surface, and the hydrophilic head groups are oriented towards the aqueous phase. Spreading occurs, for example, circularly in all directions, as indicated by the arrows, until the hydrophobic surface is completely covered, or the lipid reservoir is depleted. The tension at the spreading edge is equal to the lipid/SU-8 adhesion energy. Without wishing to be bound by any particular scientific theory, investigation of the deposited lipid film has led to the conclusion that a lipid monolayer is present. Fluorescence Recovery After Photobleaching (FRAP) experiments were employed to assess the mobility of the lipid film. The found diffusion constant is in agreement with the presence of a monolayer. The value is approximately one order of magnitude lower than the diffusion constant for suspended phospholipid bilayers. The friction between the hydrophobic tails of the lipid molecules and the SU-8 surface accounts for this low value in diffusion constant and it is concluded that the lipid is indeed spreading as a lipid monolayer with the hydrophobic tails pointing towards the SU-8 and the hydrophilic headgroups pointing towards the aqueous buffer solution. FIG. 2D shows an example where a phospholipid monolayer film is formed on SU-8 lanes by spreading after deposition of a multilamellar vesicle made from a fluorescently labeled soy bean lipid extract. As the lipid only spreads on the hydrophobic surface and not on the hydrophilic surface, this technology offers a possibility to perform controlled two-dimensional microfluidics. An interesting aspect of this technique compared to microfluidics of water-like solvents in solid channels is that for the spreading lipid film there are no fixed no-slip boundary conditions.

The technique also gives the opportunity to control lipid deposition by applying lipid sources to the SU-8 surface, monitoring the spreading with a confocal microscope, and removing the lipid source after reaching the desired coverage with a micropipette. Thus, sample injection can be exactly controlled quantitatively. These tools thus enable us to carry out mixing and chemical transformations in two dimensions on a surface. Structures of desired size in the order of square micrometers (as well as smaller and larger) e.g., from between about 0.01 μm and about several hundreds of micrometers, can be fabricated, and direct control over the amounts of chemical reactants is achieved by adding and removing lipid sources which can be doped with different compounds. This corresponds to volume fractions of different compounds in conventional chemical reactors.

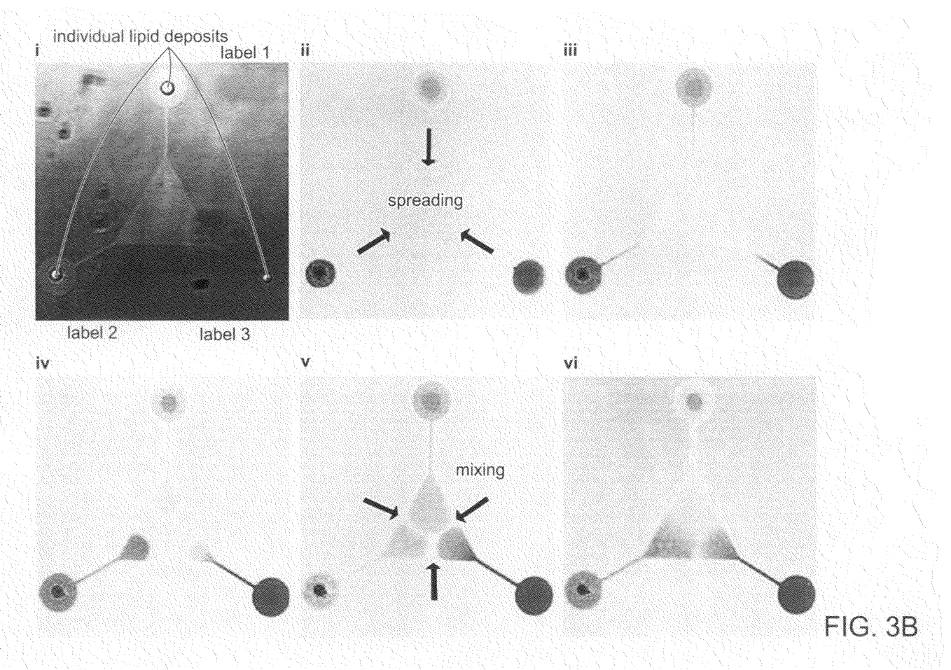

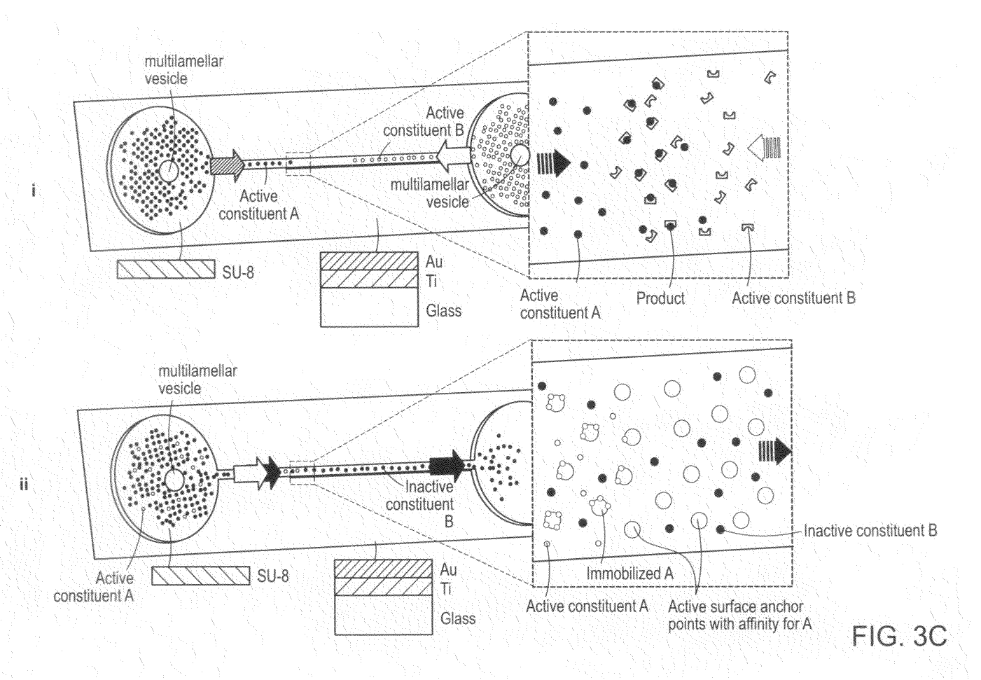

Furthermore, methods to produce phospholipid monolayer films of predefined stoichiometry comprising different lipids or reactive species and components on the device by lipid spreading and mixing is feasible. First, if two liposomes of different composition spread on SU-8, and their leading edges come into contact, they will mix their contents by diffusion. This is shown in FIG. 3A where soybean polar extract (SPE) lipid and a synthetic lipid (DOTAP) films are formed and mixed. After mixing, the formed film will contain the two components in proportion to the amount of material from the two respective patches. To further show the principle of mixing lipids stoichiometrically, one embodiment comprises SU-8 structures of known size and particular geometry to promote mixing in n-component systems (where n can be any integer larger than 1). Using a 3-component mixing device as shown in FIG. 3B, different lipid fractions can be applied consecutively to the three different injection sites and monitored how they mix in the central triangle-shaped area on the surface.

The 2-dimensional microfluidic platform thus lends itself for a variety of applications in chemical analysis and synthesis. For example, macromolecules can be assembled in a film by mixing lipids containing the respective components (reactants) necessary to form the molecule on a surface. Supramolecular aggregates may also be formed by mixing the different components of the supramolecular assembly contained in initially separate lipid fractions. For example, complementary single-stranded DNA molecules can be hybridized on the surface by supplying the two different strands in individual lipid films. To be able to perform this kind of surface chemistry it is advantageous to chemically conjugate by methods known in the art the molecules e.g., DNA with a lipid that behave as the lipids in the spreading lipid film.

The device can be utilized for reactive mixing of two or more additive components (e.g., hybridization of complementary DNA strands, dimerisation, oligomerization and polymerisation of e.g. peptides, DNAs, aromatics, lipids, alkanes, alkenes, alkynes, as well as other compounds, reactions leading to covalent bonds, mixing leading to the formation of two-dimensional crystals, supramolecular synthesis from a aggregation/association of the individual building blocks, self-assembly reactions, self organization reactions by bringing together the building blocks, fabrication of nanodevices and nanosctructures by bringing together the building blocks), which are added to the spreading lipid material, either before deposition of the lipid onto the injection area, thus spreading together with the forming lipid film, or after formation of the fully extended film. Each deposition spot can contain one or more such additive components. FIG. 3C, panel (i) shows a device comprising two deposition areas interconnected by a spreading lane. On each deposition area, lipid material is deposited as multilamellar vesicles, together with one or more active additives. The two lipid deposits spread across the lane towards each other, each carrying along the active material. Upon meeting, the functional materials interact or combine, either in a chemical reaction or by other interactions, comprising self-assembly or other association processes, catalytic processes or binding mechanisms. In FIG. 3C, panel (i), the association of two active materials is depicted. This method allows for establishment of exact ratios of active additives and therefore control over the association or reaction process. This process is not limited to two active materials or two lipid deposits, any combination of materials is possible. For example DNA hexagonal structures can be made based on click chemistry where the six or less than six different strands of the hexagon are provided by six different spreading lipid films each carrying an individual strand.

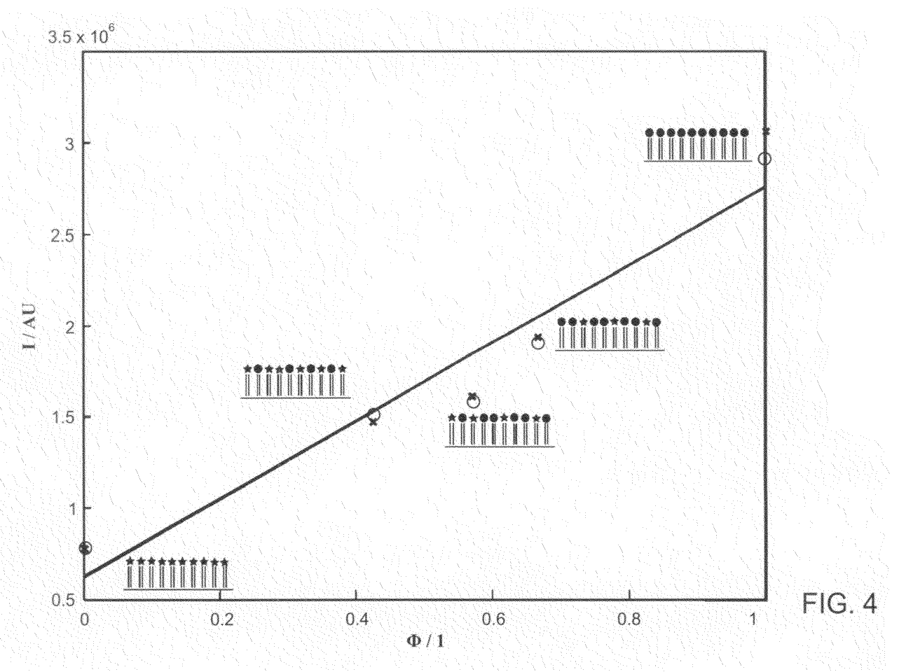

FIG. 4 shows a plot of how the integrated fluorescence intensity of two different mixtures depends on the mixing ratio (Φ) in a 2-component mixer. With this method it is thus possible to exactly determine the mixing ratio of two materials at any point in time. This means that surfaces of any composition can be synthesized on such devices in-situ.

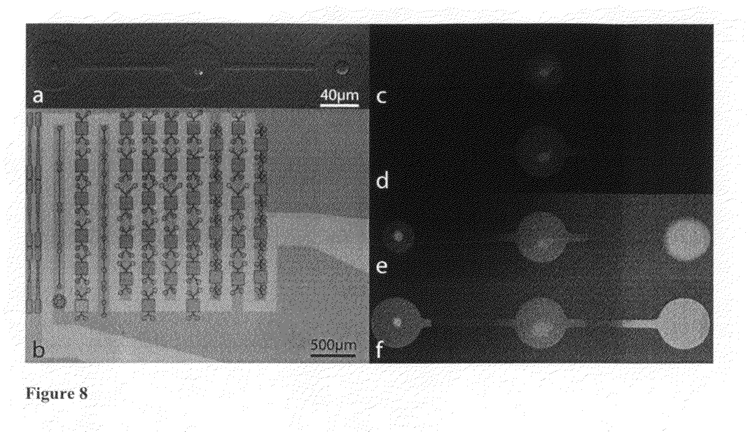

In addition, the spreading of lipid material can be influenced the by external parameters, comprising parameters such as the temperature of the surface. In one embodiment this is achieved by embedding temperature control elements into the patterned surface or by radiative methods, comprising infrared light or laser light. Temperature control is thus possible over a wide range e.g., from between about room temperature and about 95° C. In one embodiment such control elements are surface-printed resistive heating strips, heating blocks, heating coils, IR light or any other method also including techniques where a heating element is inserted into the bath solution (FIG. 2A). In association with surface-fabricated or other heating methods, temperature responsive characteristics of lipids such as phase transformations are the basis for applications: Above the phase transition point at elevated temperature, lipids are in an unordered fluid phase state and can spread on the hydrophobic surface, while below phase transition temperature the lipid is in a non-mobile crystalline phase, which leads to reversible arrest of spreading. In one embodiment, the phase transition temperatures can be conveniently controlled by the chemical structure of the applied lipids and by mixing lipids of different chemical structure. Thus temperature is one way of controlling lipid flows in two-dimensional microfluidics based on e.g. lipid spreading (FIG. 8).

Above, it was shown that phospholipids adsorb and spread on hydrophobic SU-8 supports. However, the method can be applied, for example, to adhesion of different kinds of molecules provided that they have a hydrophobic part that can interact with the surface, (e.g., chol-DNA, DNA, proteins, peptides with a hydrophobic aromatic, alkane, alkene, or alkyne conjugation). Here we show such an example with DNA after modification of the native DNA with a hydrophobic moiety (cholesterol). Specifically, we show that cholesteryl-modified oligonucleotides adsorb efficiently on SU-8, whereas non-modified, native-state oligonucleotides stay in solution. The coupling of chol-DNA to SU-8 involves a strong hydrophobic interaction. The presented immobilization route grants an advantage over other methods for DNA immobilization that involve functionalized surfaces by eliminating the need of surface activation. Furthermore, we obtained high, and reproducible hybridization yields of complementary strands to immobilized chol-DNA.

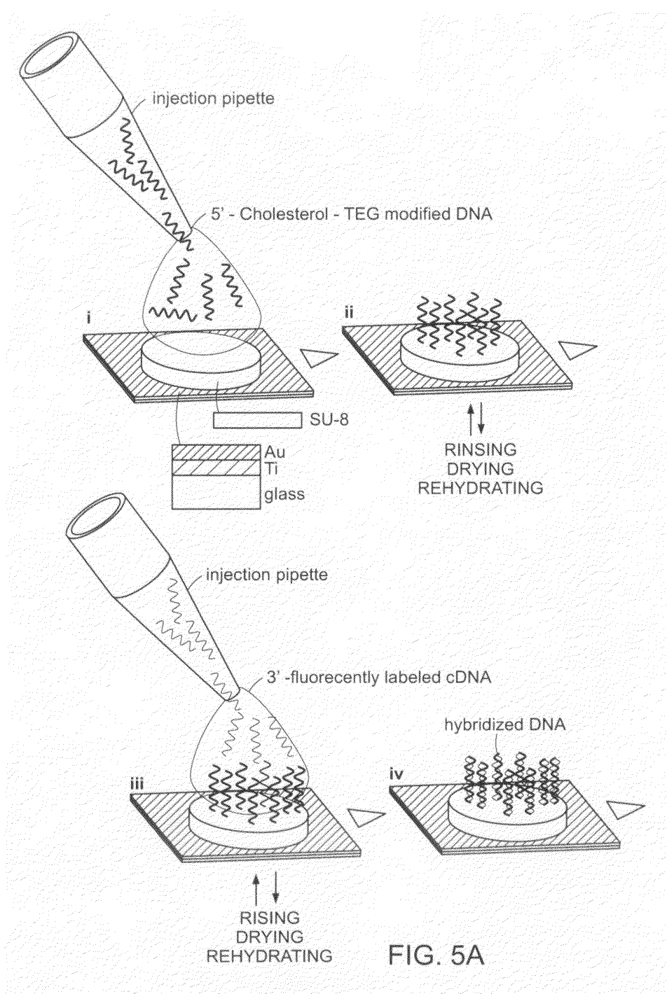

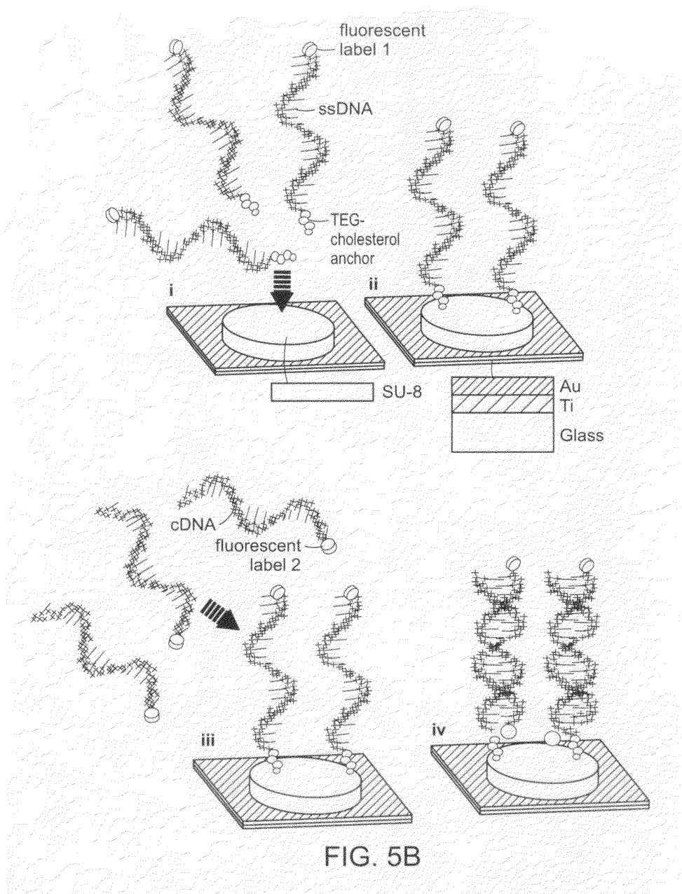

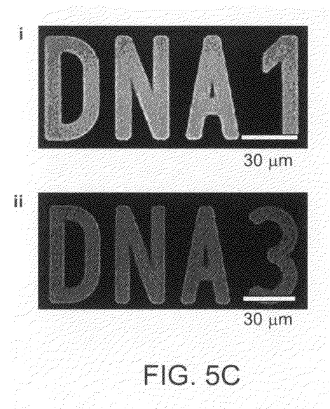

Immobilization of single-stranded DNA, conjugated to cholesterol and labeled with a fluorescent dye, to devices with hydrophobic and patterened SU-8 structures on a gold surface is schematically displayed in FIGS. 5A and 5B. The chol-DNA in solution is added to a patterned device (SU-8 on Au), and the chol-DNA attaches only to the SU-8 surface with the cholesterol moieties pointing toward SU-8. Association of the chol-DNA to the SU-8 surface is immediate and can be visualized e.g. by confocal microscopy. Depending on the dye molecule attached to the DNA, samples are excited at different wavelengths.

Furthermore, the formed DNA film is thermally stable and can be cleaned, dried and stored for prolonged periods of time. The substrate (e.g., coverslip) can, for example, be rinsed with water and subsequently dried gently under a nitrogen stream. The substrates with adsorbed DNA can be stored in the dry state for prolonged time periods.

FIG. 5C shows SU-8 structures having two different fluorescently labelled chol-DNA adsorbed to the surface.

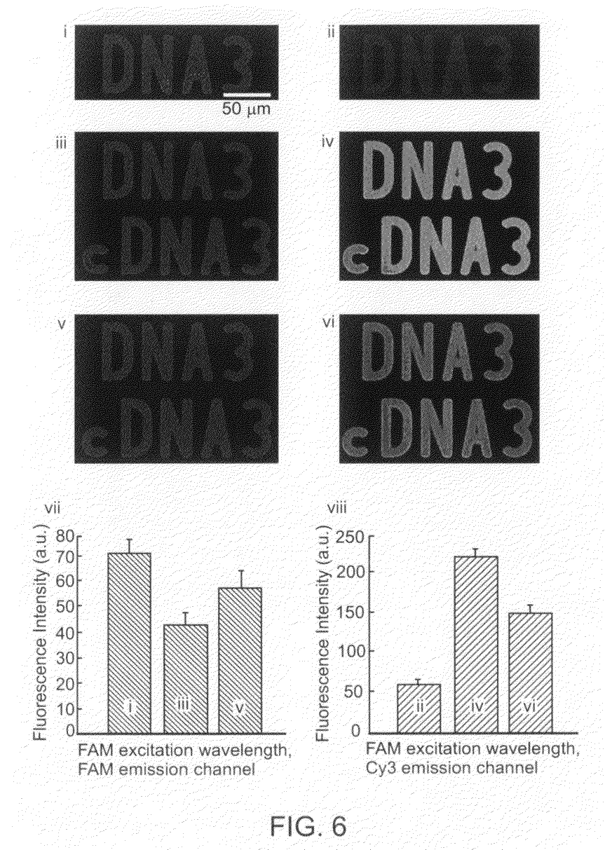

After adsorption of a first DNA strand, a second complementary strand can be added to the solution. The complementary strand then hybridizes with the surface-attached DNA. We used two different techniques to verify hybridization. First hybridization was shown by FRET between the fluorescently labeled DNA3 and its complementary c-DNA3/4 (see Table 1 for sequence and label information). In FIG. 6, the right panels (ii, iv, vi) show the emission of the acceptor whereas the left panels (i, iii, v) show the emission of the donor both being excited at donor excitation wavelength. Prior to adding the complementary c-DNA3/4, a fluorescence micrograph taken shows the immobilized DNA3 that stays on SU-8 after the coverslip was kept dry for 6 hours (FIG. 6, panel (i)). Adding the c-DNA3/4 increases the fluorescence signal of the Cy3 significantly (FIG. 6, panels (ii) and (iv)) whereas it decreases for the FAM (FIG. 6, panels (i) and (iii). After the coverslip has been rinsed, dried and rehydrated with buffer solution, the immobilized and hybridized chol-DNA+c-DNA pair was still present on the SU-8 (see FIG. 6, panels (v) and (vi)).

TABLE 1
List of Oligonucleotides

| Mole- | 5′ modifi- | 3′ modifi- | Sequence |
|---|---|---|---|
| cule | cation | cation | starting at 5′ |
| DNA1 | Chol-TEG | Cy5 | GCGAGTTTCG |
| DNA2 | Chol-TEG | | GCGAGTTTCG |
| DNA3 | 6-FAM | Chol-TEG | GCCAGTTTCGTCTAAGCACG |
| DNA4 | | Chol-TEG | GCCAGTTTCGTCTAAGCACG |
| c-DNA | | Cy3 | CGAAACTCGC |
| 1/2 | | | |
| c-DNA | Cy3 | | CGTGCTTAGACGAAACTGGC |
| 3/4 | | | |

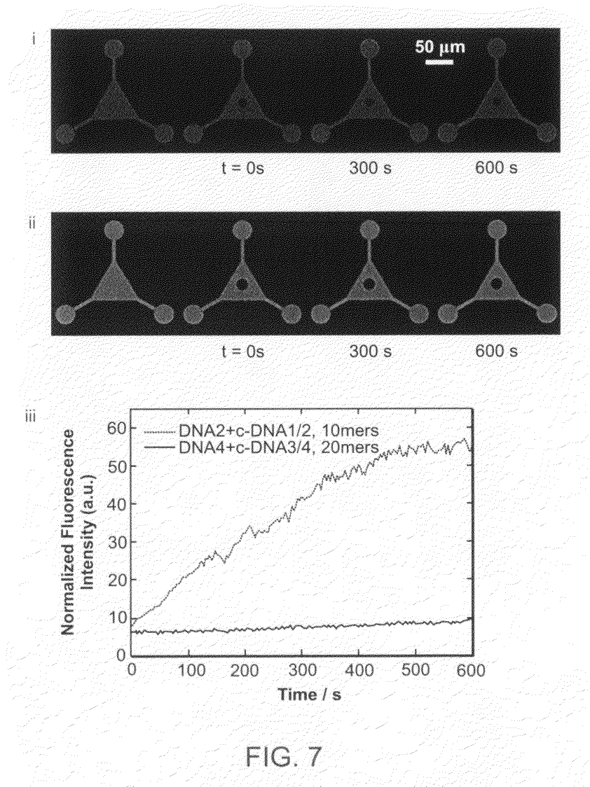

Hybridization was also detected by fluorescently labeled complementary DNA molecules which were bound to a non-fluorescent immobilized probe (see FIG. 7). Here we use DNA4+c-DNA3/4 and DNA2+c-DNA1/2 pairs and Fluorescence Recovery After Photobleaching (FRAP) was monitored. In both cases the immobilized DNA (DNA4 and DNA2) are not fluorescently labeled and evidence of hybridization comes from detection of fluorescence from the Cy3 in the complementary strands (c-DNA3/4 and c-DNA1/2). Both hybridization experiment results prove that cholesterol-modified oligonucleotides are accessible to their complementary strands, even after immobilized DNA have been kept dry for several hours.

In addition, the platform should allow for immobilization of membrane proteins. Membrane proteins generally contain transmembrane alpha-helices that are highly hydrophobic. Thus, unmodified membrane proteins should adsorb spontaneously to the surfaces presented here including SU-8.

In one embodiment the device may comprise a chip surface covered with a hydrophobic coating such as SU-8, which comprises a pattern of substructures such as perforations in the layer, wells in the layer, pillars of the same or other materials on the layer, patches, or immobilized particles, and molecules (FIG. 1D). Structures are arranged in an ordered (arrayed) or unordered manner, and are designed to be either fully or partially covered, or to be surrounded by the spreading film (e.g., based on the hydrophobicity patterning of the surface). On such a structured surface, processes comprising chemical reactions or other surface-assisted synthetic procedures, catalytic processes, supramolecular self-assembly or affinity-based separation principles between materials or reactants immobilized on or within the substructures and active constituents of the spreading film can be realized (FIG. 3C, panel (ii)). In one embodiment, reactants or active constituents can be carried by the lipid flow across the substructures, generating as a 2-dimensional microfluidic device.

In another embodiment, reactants or active constituents are added to the injection area of a structured surface and are allowed to diffuse within a preformed lipid film to reach the substructured lanes or areas. In another embodiment, such reactions can be initiated by external stimuli, comprising stimuli such as temperature gradients by using surface-printed heaters, light by using lasers or flash lamp irradiation, radiation using particle emitters, or pH-gradients by using bulk pH change or supply of acidic or basic solutions through microfluidic channels. In another embodiment, substructured surface areas can be placed on interfaces to analytical or synthetic machinery, comprising devices such as quartz crystal microbalance (QCM)-crystal surfaces or surface plasmon resonance (SPR) substrate surfaces.

In particular since SU-8 can be deposited on gold as very thin films it should be applicable to a wide range of applications for QCM and SPR.

### Methods

Described herein are methods of mixing molecules having at least one hydrophobic part, liposomes and/or molecules associated or bound therewith or thereto. Also described herein are methods of using the devices described herein.

In one aspect, methods of mixing lipid films extracted from liposomes on a surface are described. The methods comprise placing a first liposome (of a certain composition) on a hydrophobic surface, and placing a second liposome of a different composition on the hydrophobic surface, wherein the first and second liposomes spread and mix on the hydrophobic surface.

The liposomes or molecules having at least one hydrophobic part are placed on the hydrophobic surface with, for example, one or more of a micropipette, optical tweezer, or microfluidic device. For example, the liposomes may be directed through a microfluidic device to a hydrophobic surface on or in a microfluidic device. The device may further comprise one or more of a chamber, capillary, column or any other device of macroscopic or microscopic dimensions.

The methods described herein allow for precise mixing of specified quantities of materials. For example, an amount of material donated from a first and a second liposome (or amount of molecules having at least one hydrophobic part) is controlled by one or more of a size of the first and second liposomes or by timing. For example, the quantity of material of a liposome is known and thus the amount of material can be controlled by using a measured amount of liposome or molecules having at least one hydrophobic part. Also, timing can be used to control the mixing because the spreading rate can be measured as discussed herein and this known factor can be used in a calculation to determine, for example, in a mixing area of fixed size, how much time to allow spreading for a certain desired amount of material to mix. After a certain period of time, for example, an amount of one or more of the liposomes or molecules having at least one hydrophobic part can be withdrawn or removed.

In certain embodiment, the methods further comprise withdrawing at least part of one or both the first and second liposomes (e.g., after they have donated the desired amount of lipids to the surface). This allows one to obtain a stoichiometrical control of a film formed from the first and second liposomes or from any number of liposome or populations of molecules having at least one hydrophobic part.

The methods, according to one embodiment, allow the creation of a functional surface by the mixing of the first and second liposomes, or by the mixing of 1, 2, 3, 4, 5, 6, 7, 8, 9, 10, or more populations of liposomes or of populations of molecules having at least one hydrophobic part.

In one embodiment, the functional surface comprises one or more of 2- or 3-dimensional surface features. Functional surfaces may also or alternatively comprise one or more of a catalytic surface such as a surface containing a metal catalyst or an enzyme, a binding surface such as a surface containing gold spots with affinity for thiols or Ni-spots with affinity for peptide/protein His-groups, or a surface supporting a physical or chemical operation such as immobilized crown ethers chelating agents or certain functional groups.

The methods also allows, after a film has been formed from the liposomes or from the molecules having at least one hydrophobic part, for functionalizing or altering the film. This can be done, for example, by adding other molecules that bind or react with the film (e.g., in such a way that the film changes its properties).

Once applied to the hydrophobic surfaces of the substrates described herein, the liposomes (e.g., made of molecules having at least one hydrophobic part) form, for example, supramolecular structures, nanostructures, DNA arrays, protein arrays, arrays of other molecular entities, particle arrays.

The methods described herein may further comprise hybridizing site-directed molecular recognition regimes (e.g., nucleic acids, e.g., DNA) a film formed from the liposomes or molecules having at least one hydrophobic part. As described above, the molecules having at least one hydrophobic part may have associated therewith, nucleic acid, proteins, lectins and other molecules that are capable of being recognized by binding partners. The films, once formed, may be used in molecular recognition assays known to one of skill in the art.

The methods may also further comprise drying a film formed from the first and second liposomes or a film made of 1, 2, 3, 4, 5, 6, 7, 8, 9, 10, or more populations of liposomes or of populations of molecules having at least one hydrophobic part.

In one embodiment, the method comprises rehydrating films that have been dried. Films, such as the cholesteryl-conjugated DNA films are stable upon drying and rehydrating.

In one aspect, provided herein are methods of dynamic liquid film formation comprising suspending a multilamellar vesicle in buffer, placing the vesicle on a substrate comprising a hydrophobic surface, whereby the vesicle spreads as a monolayer on the surface. The method may further comprise placing a second multilamellar vesicle on the substrate, whereby the vesicle and the second vesicle spread and mix. The method may further comprise placing a third, fourth, fifth, sixth, seventh or more multilamellar vesicles on the substrate, whereby the vesicles spread and the resulting lipid films mix.

Methods may also comprise determining the coefficient of spreading of each liposome, or molecule mixture by methods disclosed herein. The liposomes and/or molecules may comprise coefficients of spreading from between about 0.01 to about several hundred μm²/s; from between about 0.5 to about 500 μm²/s; from between about 1 to about 100 μm²/s; from between about 50 to about 75 μm²/s or any sub-range or single value contained therein.

The methods disclosed herein may also be used to modify the surfaces of microfluidic channels or microcanals, or sandwich-type laminar flow cells.

Liposomes may be made by the methods described herein and by any method known to those of skill in the art, for example those methods described in US Patent Application Publication 20070059765.

The devices described herein, may be used for various measurements. The measurement mechanisms may employ any suitable detection method to analyze a sample, qualitatively and/or quantitatively. Suitable detection methods may include spectroscopic methods, electrical methods, hydrodynamic methods, imaging methods, and/or biological methods, among others, especially those adapted or adaptable to the analysis of particles. These methods may involve detection of single or multiple values, time-dependent or time-independent (e.g., steady-state or endpoint) values, and/or averaged or (temporally and/or spatially) distributed values, among others. These methods may measure and/or output analog and/or digital values.

Spectroscopic methods generally may include detection of any property of light (or a wavelike particle), particularly properties that are changed via interaction with a sample. Suitable spectroscopic methods may include absorption, luminescence (including photoluminescence, chemiluminescence, and electrochemiluminescence), magnetic resonance (including nuclear and electron spin resonance), scattering (including light scattering, electron scattering, and neutron scattering), diffraction, circular dichroism, and optical rotation, among others. Suitable photoluminescence methods may include fluorescence intensity (FLINT), fluorescence polarization (FP), fluorescence resonance energy transfer (FRET), fluorescence lifetime (FLT), total internal reflection fluorescence (TIRF), fluorescence correlation spectroscopy (FCS), fluorescence recovery after photobleaching (FRAP), fluorescence activated cell sorting (FACS), and their phosphorescence and other analogs, among others.

Electrical methods generally may include detection of any electrical parameter. Suitable electrical parameters may include current, voltage, resistance, capacitance, and/or power, among others.

Hydrodynamic methods generally may include detection of interactions between a particle (or a component or derivative thereof) and its neighbors (e.g., other particles), the solvent (including any matrix), and/or the microfluidic system, among others, and may be used to characterize molecular size and/or shape, or to separate a sample into its components. Suitable hydrodynamic methods may include chromatography, sedimentation, viscometry, and electrophoresis, among others.

Imaging methods generally may include detection of spatially distributed signals, typically for visualizing a sample or its components, including optical microscopy and electron microscopy, among others.

Biological methods generally may include detection of some biological activity that is conducted, mediated, and/or influenced by the particle, typically using another method, as described above. Suitable biological methods are well known to those of skill in the art.

The measurement method may detect and/or monitor any suitable characteristic of a particle, directly and/or indirectly (e.g., via a reporter molecule). Suitable characteristics may include particle identity, number, concentration, position (absolute or relative), composition, structure, sequence, and/or activity among others. The detected characteristics may include molecular or supramolecular characteristics, such as the presence/absence, concentration, localization, structure/modification, conformation, morphology, activity, number, and/or movement of DNA, RNA, protein, enzyme, lipid, carbohydrate, ions, metabolites, organelles, added reagent (binding), and/or complexes thereof, among others. The detected characteristics also may include cellular characteristics, such as any suitable cellular genotype or phenotype, including morphology, growth, apoptosis, necrosis, lysis, alive/dead, position in the cell cycle, activity of a signaling pathway, differentiation, transcriptional activity, substrate attachment, cell-cell interaction, translational activity, replication activity, transformation, heat shock response, motility, spreading, membrane integrity, and/or neurite outgrowth, among others.

Substrates may be used for any suitable virally based, organelle-based, bead-based, and/or vesicle-based assays and/or methods. These assays may measure binding (or effects) of modulators (compounds, mixtures, polymers, biomolecules, cells, etc.) to one or more materials (compounds, polymers, mixtures, cells, etc.) present in/on, or associated with, any of these other molecules. Alternatively, or in addition, these assays may measure changes in activity (e.g., enzyme activity), an optical property (e.g., chemiluminescence, fluorescence, or absorbance, among others), and/or a conformational change induced by interaction.

In some embodiments, films may include detectable codes. Such codes may be imparted by one or more materials having detectable properties, such as optical properties (e.g., spectrum, intensity, and or degree of fluorescence excitation/emission, absorbance, reflectance, refractive index, etc.). The one or more materials may provide nonspatial information or may have discrete spatial positions that contribute to coding aspects of each code. The codes may allow distinct samples, such as cells, compounds, proteins, and/or the like, to be associated with beads having distinct codes. The distinct samples may then be combined, assayed together, and identified by reading the code on each bead. Suitable assays for cell-associated beads may include any of the cell assays described above.

Suitable protocols for performing some of the assays described in this section are included in Joe Sambrook and David Russell, Molecular Cloning: A Laboratory Manual (3rd ed. 2000), which is incorporated herein by reference.

### EXAMPLES

### Example 1

### Device Fabrication

Microscope coverslips No. 1 from Menzel Glaser were cleaned and spin coated with SU-8 2000 type photoresist (Microchem) at 3000 rpm for 1 min, followed by soft-baking at 65° C. and 95° C. The coverslips were then exposed to UV light at 400 nm (5 mW/cm²) in a Karl Süss MJB3-UV 400 mask aligner for 15 s. The SU-8 coated coverslip was then subjected to a post-exposure baking step at 65° C. and 95° C., before it had been submerged in SU-8 developer (Microresist Technology GmbH). In the final step, SU-8 was rinsed with water, blow-dried with nitrogen and hard-baked in a Venticell drying (MMM Medcenter Einrichtungen GmbH) at 200° C. for 30 min. For structured SU-8 surfaces, layers of titanium and gold were sputtered onto the borosilicate coverslips prior to SU-8 application with an MS 150 Sputter system (FHR Anlagenbau GmbH). A titanium adhesion layer (thickness 2 nm) and a gold layer (thickness 8 nm) were deposited onto the coverslips with DC magnetron sputtering at a deposition rate of 5 Å/s and 20 Å/s, respectively.

The Dark-field photomask for the SU-8 process was prepared on a JEOL JBX-9300FS electron beam lithography system. A UV-5/0.6 resist (Shipley Co.) coated Cr/soda-lime mask was exposed, developed and etched using a common process for micrometer resolution (Zhang, J. et al., Micromech. Microeng. 11:20-26 (2001)).

Pattern files were prepared on the CADopia IntelliCAD platform v3.3 (IntelliCAD Technology Consortium). Except for the hard-baking steps, all fabrication procedures were executed under cleanroom atmosphere (class 3-6 according to ISO 14644-1).

### Contact Angle Measurement

Dynamic contact angle measurements were proceeded with Milli-Q water in a Drop Shape Analysing System 10Mk2 (Krüss GmbH). The data retrieved were analysed with the DSA v1.80 software.

### Example 2

### Lipid Spreading and Mixing

Example 2 describes the controlled, dynamic formation of liquid films and mixing of several different lipid films on microfabricated hydrophobic substrates (device of example 1). In contrast to previous methods of fabrication, this method allows for stoichiometric control of the different components included in the film. When multilamellar lipid vesicles suspended in a buffer droplet are placed on the substrate, the lipid rapidly spreads as a monolayer on the surface. The formed lipid patches are circular as illustrated in FIG. 2C. The multilamellar vesicles are eventually depleted and transformed into a lipid monolayer.

Mixing of lipid films with different compositions is achieved, for example, by sequencially applying a mixture of multilamellar vesicles SPE (soybean polar extract, overall negatively charged) lipids and DOTAP (a synthetic, positively charged lipid) multilamellar vesicles to adjacent areas on the device surface. A time series of images of the mixing of the two lipid monolayers is shown in FIG. 3A. In the experiment, SPE lipid was labelled with the fluorescent dye FM1-43, while DOTAP was unmodified. As the mixing proceeds, the fluorescence intensity in the SPE lipid patch decreases because the concentration increase in DOTAP leads to the displacement of the stain. If the lipid films were not mixing, one would obtain a stationary, discrete border in fluorescence intensity between the two films.

Monolayer films are formed with the hydrophobic tails of the lipid molecules pointing towards the device surface and the hydrophilic headgroups exposed to the buffer solution (see FIG. 2C). To confirm and quantify the mobility of the lipid molecules, fluorescence recovery after photobleaching (FRAP) experiments were conducted and the diffusion constant D was calculated to be 2.3·10⁻¹ μm²/s. In the mixing experiments, multilamellar vesicles were deposited onto the device surface, using a microtransfer technique. This allows for formation of lipid films with controlled composition on the hydrophobic areas (e.g. comprising SU-8, see Example 1). On this device, a lipid film does not form on Au, which in contrast to SU-8 is hydrophilic and does not promote lipid spreading. Binary and ternary mixing structures were used having two, and three injection areas for multilamellar vesicles, respectively, and one centrally placed mixing region. FIG. 2A shows a schematic drawing of the experimental set-up, which allows to control deposition of lipid in the injection areas, to monitor spreading and mixing and to remove lipid sources with a micropipette on demand. Lipids can be mixed stoichiometrically by applying different lipid films in known quantities to the two injection areas on the type of structure shown in FIG. 1C (upper row). With one of the lipid fractions fluorescent, and the other one not fluorescent, dilution of the two lipid films in each other could be monitored and the fluorescence intensity at different film mixing ratios Φ, was determined (FIG. 4). The relation is linear (R²=0.944), which shows that the system can be calibrated.

FIG. 3B shows a ternary mixing device on which three differently stained multilamellar vesicles have been placed. The spreading lipid monolayers are mixing in the centre of the structure. The mixing ratio of the applied lipid fractions can be controlled by timing of application and removal of lipid sources.

The spreading coefficient β of lipid flux on a lane is in the range of 1-5 μm²/s, independent of the line width w. The total flux of lipid over a lane is proportional to the lane width w. This means, that the ratio of the widths of two lanes w_{A}/w_{B}, leading to the central mixing area of a mixing device equals the mixing ratio Φ between the lipid fractions A and B spreading on these lanes. This shows that it is in principle possible to control lipid mixing ratios in the mixed monolayer by topographical design of the structure.

### Lipid Spreading Procedure

A bare coverslip was placed on the microscope stage and a solution of rehydrated lipids was applied to it. With the microtransfer technique, it was possible to aspirate the desired amount of lipid into the pipette in the form of a multilamellar vesicle. This micropipette was then carefully removed from the drop. A coverslip with sputtered Ti/Au and SU-8 structures was then placed on the stage instead and a drop of PBS buffer was applied. The micropipette was then lowered into the droplet and the aspirated lipid was applied at the desired site within the microfabricated pattern. The procedure was then repeated to move another lipid fraction, e.g., labelled with a different fluorophore onto the Ti/Au coverslip with SU-8 pattern. FIG. 2A illustrates the experimental set-up at the confocal microscope.

### Chemicals

Soybean polar extract (SPE) lipid was purchased from Avanti Polar Lipids, Alabaster (AL), USA. KCl, DOTAP, TRIZMA Base, K₂-EDTA, K₃PO₄, KOH and glycerol (99%) were obtained from Sigma (Steinheim, Germany). Deionised water was taken from a Milli-Q system of Millipore (Bedford (MA), USA). FM1-43 and Rhodamine phosphatidylethanolamine (Rhodamine PE) were obtained from Molecular Probes (Eugene (OR), USA). Chloroform was purchased from VWR International AB (Stockholm, Sweden). MgSO₄ and KH₂PO₄ were obtained from Merck (Darmstadt, GEermany). The used phosphate buffer (PBS) contained 5 mM TRIZMA Base, 30 mM K3PO4, 30 mM KH₂PO₄, 1 mM MgSO₄ and 0.5 mM EDTA in deionised water, pH7.8 adjusted with KOH. Fluorescent Alexa 633 Fluor-phosphatidylethanolamine was synthesised by stirring Alexa 633 Fluor succinimidyl ester (Molecular Probes) with phosphatidylethanolamine (Sigma) in anhydrous methylenechloride (Aldrich) at ratio 1:5 under N₂ atmosphere for 25 hours. Lipids were prepared as described by Karlsson et al. (Karlsson M. et al., Anal. Chem. 726:5857-5862 (2000)).

In short, the lipid solution (DOTAP (Sigma) or soybean polar extract (SPE) lipid doped with 1% (w/w) 1,2-dioleoyl-sn-glycero-3-phosphoethanolamine-N-(carboxyfluorescein) (both Avanti Polar Lipids), 1% (w/w) rhodamine phosphatidylethanolamine, FM1-43 (both Molecular Probes), or Fluorescent Alexa 633 Fluor-phosphatidylethanolamine) was dried under reduced pressure for at least 40 min and rehydrated with PBS buffer (5 mM TRIZMA Base, 30 mM K₃PO₄, 0.5 mM K₂-EDTA (all Sigma), 30 mM KH₂PO₄, 1 mM MgSO₄ (both Merck), adjusted with KOH (Sigma) to pH7.8) for approximately 10 min

### Preparation of Giant Multilamellar Vesicles

The formation of GMVs, e.g., from about 1 to about 100 μm; from between about 5 and about 75 μm; from between about 25 and about 50 μm or any sub-range or single value contained therein was performed in a two-step procedure; dehydration of the lipid dispersion followed by re-hydration. For dehydration, a small volume (2 μl) of lipid-suspension was carefully placed on a borosilicate coverslip and placed in a vacuum desiccator. When the sample was completely dry, the dehydration was terminated and the sample was allowed to reach room temperature. The dry sample was first rehydrated with 5 μl buffer. After 3-5 min the sample was carefully diluted with buffer, minimizing turbulence in the sample. All rehydration liquids were warmed to at room temperature before use.

### Preparation of Injection Tips

Injection tips were prepared from borosilicate filament bearing capillaries (length: 10 cm, o.d.: 1 mm, i.d.: 0.78 mm; Clark Electromedical Instruments, Reading, UK) that were carefully flame-forged in the back ends to make entrance into the capillary holder easier. The capillaries were flushed with a stream of compressed air before use to remove dust particles. The tips were pulled on a CO₂-laser puller instrument (Model P-2000, Sutter instrument Co., Novato, Calif.). The outer diameter of the injection tips varied between 0.25-2.5 μm. To avoid contamination, tips were pulled immediately before use.

### Micromanipulation and Microinjection

All micromanipulation and material injection experiments were performed on an inverted microscope (Leica DM IRB, Wetzlar, Germany) equipped with a Leica PL Fluotar 40× objective and a water hydraulic micromanipulation system (high graduation manipulator: Narishige MWH-3, Tokyo, coarse manipulator: Narishige MC-35A, Tokyo).

### Imaging

Confocal imaging experiments were carried out with a Leica IRE2 confocal microscope equipped with a Leica TCS SP2 confocal scanner. Data were processed and analysed with Matlab v7.1 (R14) and Leica Confocal Software v2.61.

Fluorescence Recovery after Photobleaching

Fluorescence Recovery after Photobleaching (FRAP) was carried out on an SPE lipid patch which was doped with a mole fraction of 1% (w/w) of fluorescent rhodamine phosphatidylethanolamine. The lipid source was removed from the patch to avoid the net flow of lipid from the multilamellar vesicle. A part of the lipid patch was bleached by 5 s of intense laser radiation and the recovery was recorded. The recovery was then fitted to a modified Bessel function and the “characteristic” diffusion time was estimated. Data were processed and analysed with Matlab v7.1(R14) and Leica Confocal Software v2.61.

### Lipid Spreading Applications

A multilamellar lipid vesicles suspended in a buffer droplet placed on the SU-8 substrate rapidly spreads as a monolayer on the surface. The formed lipid patches are circular as shown in FIGS. 2C and 3Aa. The multilamellar vesicles are eventually depleted and transformed into a lipid monolayer. The tension induced by SU-8 is sufficient to disrupt the structure of the multilamellar vesicle. Therefore, the surface adhesion energy of lipids on SU-8, Σ, is larger than the lysis tension of bilayer membranes σL≈2-9 mN/m. The adsorbed lipid screens the hydrophobic surface energy between SU-8 and water, and the gain in surface energy associated with lipid adsorption, Σ, is expected to be roughly equal to the surface tension between SU-8 and water. SU-8 is an epoxy and it is therefore reasonable to assume that the surface tension SU-8/water could be as high as σ_{epoxy}≈47 mN/m. The dynamics of the lipid spreading process were quantified and it was found that the wetted area A over time is approximately linear at the beginning of the spreading process. The dynamics of spreading was modelled by balancing the lipid film Marangoni stress V̅σ with the sliding friction force between lipid film and surface (per unit area): V̅σ−ξv=0. For lipid film spreading on a lane of SU-8, the spreading velocity is ν=√βt where β=S/2ξ is the spreading coefficient and the spreading power S is the difference in free energy between lipids on the surface and lipids in the reservoir (per unit area). The lipid film velocity on a lane is uniform over the film, whereas for circular spreading there is a gradient in velocity. For circularly spreading monolayers we find that the radius of the spreading film is given by R log (R/R₀) dR/dt=2β. Taking R₀ equal to the mean radius of the spreading multilamellar vesicles and solving this equation numerically, yields a good fit with the experimental data. The estimated spreading coefficients are in the range β=1-3 μm²/s.

The tension at the spreading edge is equal to the lipid/SU-8 adhesion energy σ(R)=Σ. At the multilamellar vesicle the tension is expected to be equal to the lysis tension of a bilayer membrane σ(R₀)=σ_{L}, and the spreading power is S=Σ−σ_{L}. Taking Σ˜σ_{L}˜6 mN/m and, β≈3 μm²/s, the sliding friction between monolayer and SU-8 is estimated to be of the order ξ˜10⁹ Pas/m, which is of the same order of magnitude as the sliding friction, bₘ=0.5-10⁹ Pas/m, between the two sheets in a lipid bilayer membrane. This strongly supports the notion of a lipid monolayer on hydrophobic SU-8, with interactions very similar to the interactions between the sheets in a lipid bilayer membrane.

In order to demonstrate mixing of lipid films with different composition, we applied a mixture of multilamellar vesicles of soybean polar extract (SPE) lipids and DOTAP multilamellar vesicles to the SU-8 surface. DOTAP is a synthetic, positively charged lipid, while SPE is a mixture of lipids which are overall negatively charged. Images of the mixing of the two lipid monolayers are shown in FIG. 3A. The SPE lipid was stained with the fluorescent dye FM1-43, while DOTAP was unstained. As the mixing proceeds, the fluorescence intensity in the stained SPE lipid patch decreases because the concentration increase in DOTAP leads to the displacement of the stain. If the lipid films would not be mixing, one would obtain a stationary, discrete border in fluorescence intensity between the two films.

We next developed a platform based on a microtransfer technique for deposition of multilamellar vesicles onto patterned substrates with differential hydrophobicity. This platform allows for formation of lipid films with controlled composition. We made SU-8 patterns on Au which in contrast to SU-8 is hydrophilic and does not promote lipid spreading. Since SU-8 is a photoresist, it offers the opportunity to generate structures on the micrometer scale whose shape we designed to support lipid film formation and controlled stoichiometric mixing. We made binary and ternary mixers having two, and three injection pods for multilamellar vesicles, respectively, and one centrally placed mixing region. FIG. 2a is a schematic of the experimental setup. The set-up gives us the opportunity to control injection of lipid to the injection pods, to monitor spreading and mixing and to remove lipid sources with a micropipette again. We were able to mix lipids stoichiometrically by applying different lipid films in known quantities to the two injection pods on the type of structure shown in FIG. 2a. One of the lipid fractions was fluorescent, while the other one was not. We monitored the dilution of the two lipid films in each other and determined the fluorescence intensity at different film mixing ratios Φ, shown in FIG. 4. One can see that the relation is linear (R²=0.944), which shows that the system can be calibrated.

Furthermore, the dynamics of lipid monolayer mixing can be followed. Obviously, a wide range of lipid mixing ratios can be found on the surface. One can see that for significant changes in fluorescence intensity to occur, it takes several minutes. First of all, the comparatively low diffusion constant of the lipid makes this type of investigation convenient. Secondly, the purposeful design of the SU-8 structure, which are rhombs with limited junction size in between them, contributes to decelerated mixing compared to a simple line between the terminal injection pods.

FIG. 3B shows a ternary mixing device on which three differently stained multilamellar vesicles have been placed. The spreading lipid monolayers are mixing in the centre of the structure. We are furthermore capable of producing structures of higher order for mixing four or more different lipid films. The mixing ratio of the applied lipid fractions can be controlled by timing of application and removal of lipid sources. We measured that the spreading coefficient β of lipid flux on a lane is in the range of 1-5 μm²/s, independent of the line width w. When the lane is long compared to the lane width, the dissipation due to surfactant flow on the lipid injection pod is negligible compared to the dissipation on the lane and νₗₐₙₑ=√β/t, where t=0 is the time when the lipid enters the lane from the injection pod. The total flux of lipid over a lane is therefore proportional to the lane width w. This means, that the ratio of the widths of two lanes wA/wB, leading to the central mixing area of a mixing device equals the mixing ratio Φ between the lipid fractions A and B spreading on these lanes. This shows that we are in principle able to control lipid mixing ratios in the mixed monolayer by topographical design of the structure.

### Example 3

### Immobilization of Oligonucleotides

Example 3 is a rapid and simple, one-step procedure for high-yield immobilization of cholesteryl-tetraethyleneglycol-modified oligonucleotides (chol-DNA) on hydrophobic areas of a device as described in example 1, comprising microfabricated SU-8 sites on a gold surface (see FIG. 1).

The process is straightforward, with the interactions between the substrate and the DNA presumably based on the hydrophobic nature of the device features and the cholesteryl-TEG modification at the 5′ or 3′ position of the oligonucleotide. The immobilized DNA on SU-8 shows robust and efficient attachment, high surface coverage, and is accessible to hybridization by complementary strands. Surface coverage values for DNA immobilization by covalent attachment are in the range of 10¹²-10¹³ molecules/cm² (20-95 pmol/cm²). The immobilized chol-DNA is still functional after being kept dry for varying durations (up to several hours), thus exhibiting shelf life. Chol-DNA (see Table 1) immobilization and hybridization monitoring were carried out by fluorescence detection via laser scanning confocal microscopy (LSCM).

### Immobilization of DNA

Solutions containing chol-DNA were pipetted and incubated on the device (see FIG. 5A). Upon application of the droplet, chol-DNA adsorbed to the SU-8 surface within seconds. Following rinsing, drying, and rehydration of the coverslip chip with buffer solution, fluorescence images were recorded. FIG. 5C panel (i) and (ii) shows the immobilized DNA1 and DNA3 after 15 and 25 minutes of incubation time, respectively. Control experiments performed using the cholesterol-free c-DNA3/4 clearly shows that the SU-8 surface is virtually DNA-free (data not shown), owing to the fact that cholesterol plays a critical role in the adsorption of DNA to the SU-8 surface.

The surface coverage of immobilized Chol-TEG-5′-GCGAGTTTCG-3′-Cy5, and Chol-TEG-5′-GCGAGTTTCG-3′ was determined using a UV-Vis spectrophotometer and the adsorbed amount of chol-DNA was calculated. The surface density of chol-DNA was in the range of 20-95 pmol/cm² corresponding to 10¹²-10¹³ molecules/cm² and can be compared to the maximal immobilization density of a monolayer of ssDNA, 150 pmol/cm². The area covered by one ssDNA molecule was, thus, measured to be between 333 Å²-1250 Å². The high surface coverage and yield in immobilization efficiency is in strong relation with confocal micrographs where one can see that the adsorbed layer is compact and free from defects. To confirm the stability of the SU-8 cholesterol interaction, the device with immobilized chol-DNA were kept dry in ambient air at room temperature for 6 hours and then rehydrated with buffer solution. From fluorescence intensity data it was calculated that only ˜40% immobilized chol-DNA was lost after storage in air.

Hybridization of Complementary DNA to ssDNA Bound to SU-8

Solutions containing fluorescently labeled chol-DNA were pipetted and incubated on the device (FIG. 5B, Panels (i) and (ii)). After incubation, the device is rinsed and fluorescently labeled complementary ssDNA containing solution is added. Upon application complementary ssDNA is hybridized to immobilized chol-DNA (FIG. 5B, Panels (iii) and (iv)). FIG. 6, panel (i) shows FAM-label emission and FIG. 6, panel (ii) shows Cy3-label emission both under FAM-label excitation wavelength when DNA3 is immobilized on the device and kept dry for 6 hours. Then c-DNA3/4 is added and hybridization is monitored via fluorescence resonance energy transfer (FRET). The donor, FAM-label, is excited and emission at the donor and acceptor is recorded, the latter showing that hybridization occurs. Fluorescence signal of the FAM-label decreases (see FIG. 6, panel (iii)) whereas it increases significantly for Cy3-label (see FIG. 6, panel (iv)). FIG. 6, panel (v) shows FAM-label emission and FIG. 6, panel (vi) shows Cy3-label emission both under FAM-label excitation wavelength showing that immobilized and hybridized DNA is still present on SU-8 surface after the device had been rinsed and rehydrated with buffer solution. The fluorescence signal intensity change is represented in FIG. 6, panels (vii) and (viii) and it demonstrates immobilization and hybridization steps, i.e. the fluorescence intensity increase and decrease. Furthermore, hybridization is also shown by detection of fluorescence from Cy3-label in the complementary strand which is bound to immobilized non-fluorescent ssDNA using DNA2+c-DNA1/2 (see FIG. 7, panel (i) and DNA4+c-DNA3/4 (see FIG. 7, panel (ii)) couples. Using a high laser intensity a region of interest is bleached and fluorescence recovery of the bleached spot (see FIG. 7C) was monitored under Cy3-label excitation wavelength. In conclusion, the results from hybridization experiments prove that cholesterol-modified oligonucleotides are accessible to their complementary strands, even after the immobilized DNA have been kept dry for several hours.

### Chemicals and DNA Probes

All experiments were performed in phosphate buffer (pH 7.8 adjusted with KOH) that contained 5 mM TRIZMA base, 30 mM K₃PO₄, 30 mM KH₂PO₄, 1 mM MgSO₄ and 0.5 mM EDTA in deionized water. 10 and 20 mer oligonucleotides were purchased from ATDbio (Southampton, UK) and Medprobe (Lund, Sweden), respectively. Before conducting the experiments, DNA concentrations were worked out by absorbance measurements with a CARY 4000 UV-Visible Spectrophotometer from Varian (Victoria, Australia).

### Substrate Preparation

Microscope coverslips (25 mm×50 mm) from Menzel Glaser (Braunschweig, Germany) were used as substrates. The coverslips were thoroughly cleaned by 5 min sonication in deionized water, followed by a plasma cleaning step in a Tepla Plasma Batch System 300; a microwave plasma system of AMO GmbH (Aachen, Germany), with oxygen plasma at 250 W for 2 min. Before applying the SU-8 photoresist, an MS 150 Sputter system of FHR Anlagenbau GmbH (Ottendorf-Okrilla, Germany) with a base pressure of 5·10⁻⁷ mbar in the main chamber is used for deposition of the Ti/Au film onto the cleaned coverslips. A titanium adhesion layer (2 nm) and a gold layer (8 nm) were deposited onto the coverslips with DC magnetron sputtering at a deposition rate of 5 Å/s and 20 Å/s respectively, at 5·10⁻³ mbar process pressure. The darkfield photomask for the SU-8 process was prepared on a JEOL JBX-9300FS electron beam lithography system. A UV-5/0.6 resist (Shipley Co., 455 Forest St., Marlborough, USA) coated Cr/soda-lime mask blank (3″ size) was exposed, developed and etched using a common process for μm resolution. Pattern files were prepared on the CADopia Intellicad platform. Prior to applying the resist, gold coated coverslips were rinsed with deionized water and blow dried with nitrogen. Then, commercially available SU-8 2002 from MicroChem (Newton, USA) was spin-coated at 3000 rpm onto the sputtered Ti/Au film. After applying the photoresist, soft bake at 65° C. and 95° C. for 6 min, UV-light exposure through a mask at 400 nm, 6 mW/cm² in a Karl Süss MJB3-UV 400 mask aligner for 15 s, post exposure bake at 65° C. and 95° C. for 1 min and development in SU-8 developer bath from Microresist Technology GmbH (Berlin, Germany) had been carried out. Finally, coverslips were copiously rinsed with deionized water, blow dried with nitrogen and hard-baked in a Venticell oven from MMM Medcenter Einrichtungen GmbH (Gräfelfing, Germany) at 200° C. for 30 min.

### Contact Angle Measurements

Dynamic contact angle measurements on SU-8 and gold surface were carried out with MilliQ water in a prop Shape Analysing System 10Mk2 of Krüss GmbH (Hamburg, Germany).

### DNA Absorbance Measurements

Solutions of DNA1 and DNA2 of 1, 2, 3, and 4 μM were prepared using PBS buffer. Concentrations of stock solutions were determined with UV-Vis spectrophotometer. Following that, a droplet of stock solution was applied to an SU-8 surface of defined area. After 15 minutes of incubation at room temperature, the supernatant was removed and its absorbance spectrum was recorded. The concentration difference between the stock solution and the supernatant yielded the adsorbed amount of DNA molecules on the SU-8 surface from which the immobilized DNA density was worked out.

### Immobilization And Hybridization Detection

Fluorescently labeled oligonucleotides were scanned with a Leica IRE2 confocal microscope equipped with a Leica TCS SP2 scanner (Wetzlar, Germany). Immobilization and hybridization experiments were carried out at room temperature and in open atmosphere. For immobilization experiments, an SU-8 structured coverslip was placed on the stage of the confocal microscope and a 2 μM, 250 μL solution containing chol-DNA molecules was manually pipetted onto the coverslip. After the defined incubation period, 15 min for DNA1 and DNA2 and 25 min for DNA3 and DNA4, the coverslip was rinsed with MilliQ water and the dried gently under a nitrogen stream. Then, the coverslip was rehydrated with buffer and fluorescence micrographs were recorded for fluorescently labeled chol-DNA molecules. The same procedure was also repeated for hybridization experiments, only differing in the rehydration step. Instead of rehydrating with buffer solution, a coverslip containing immobilized chol-DNA was rehydrated with a 2 μM, 250 μL solution containing complementary DNA. After the defined incubation period, 15 min for c-DNA1/2 and 25 min. for c-DNA3/4, the coverslip was rinsed with MilliQ water and the dried gently under nitrogen stream. Then the coverslip was rehydrated with buffer and fluorescence micrographs were recorded. For DNA4+c-DNA3/4 and DNA2+c-DNA1/2 probe couples fluorescence recovery after photobleaching (FRAP) experiments were carried out. A region of interest was bleached using a high intensity laser. Then fluorescence recovery was monitored.

### Chip Fabrication

For microchip fabrication, a Ti/Au layer was first sputtered on top of a microscope glass coverslip followed by SU-8 spin-coating. Micrometer-sized SU-8 structures were patterned using UV-light exposure through a mask. The chip was in the end hardbaked at 200° C. for 30 minutes. The final microfabricated chip thus contained two layers with distinctive surface properties. The gold surface is hydrophilic (contact angle with water: 77.9°±3.2°) and the SU-8 structures are hydrophobic (contact angle with water: 91.4°±1.5°).

SU-8 Auto-Fluorescence and Surface Coverage of ssDNA

To be able to distinguish the DNA probe fluorescence from the auto-fluorescence of SU-8, we scanned the patterned SU-8 surface at different excitation wavelengths. A decrease in the SU-8 layer thickness leads to lower auto-fluorescence (Marie, E. et al. Biosensors and Bioelectronics 21, 1327-1332 (2006)) However, our SU-8 layer was approximately 2 μm thick, and its auto-fluorescence only needs to be taken into account when using an excitation wavelength of 488 nm. The surface coverage of immobilized Chol-TEG-5′-GCGAGTTTCG-3′-Cy5, and Chol-TEG-5′-GCGAGTTTCG-3′ was determined using a UV-Vis spectrophotometer. Absorbance measurements of chol-DNA containing stock solution, and samples collected from the droplet applied to the chip were recorded. From the concentration difference the adsorbed amount of chol-DNA was calculated. The surface density of chol-DNA was in the range of 20-95 pmol/cm² corresponding to 10¹²-10¹³ molecules/cm². This result can be compared to 150 pmol/cm² which is the maximum immobilization density of a monolayer of ssDNA (where the molecules are considered to be cylinders with a 20 Å diameter and oriented perpendicular to the plane of the surface). The area covered by one ssDNA molecule was, thus, between 1250 Å²-333 Å² in our experiments. As a comparison, the theoretical area coverage of one ssDNA molecule in a closely packed full monolayer of ssDNA (without cholesteryl-TEG modification) is 111 Å².

Immobilization Detection and ssDNA-Chip Stability

Chol-DNA (see Table 1) immobilization and hybridization monitoring were carried out by fluorescence detection via laser scanning confocal microscopy (LSCM). Solutions containing chol-DNA were pipetted and incubated on the chip (see FIG. 5A). Upon application of the droplet, chol-DNA adsorbed to the SU-8 surface within seconds. Following rinsing, drying, and rehydration of the chip with buffer solution, fluorescence images were recorded. FIG. 5C panel (i) and (ii), shows the immobilized DNA1 and DNA3 after 15, and 25 minutes of incubation time, respectively. Control experiments performed using the cholesterol-free c-DNA3/4 clearly show that the SU-8 surface is virtually DNA free (data not shown). These results strongly suggest that cholesterol plays a critical role in the adsorption of DNA to the SU-8 surface. Increasing incubation times and concentrations, both for the 10- and 20-mers of DNA, do not significantly change the fluorescence intensity (data not shown). This suggests that the SU-8 surface is easily saturated with chol-DNA. To investigate the stability of the SU-8 cholesterol interaction, chips with immobilized chol-DNA were kept dry on the shelf for 6 hours and then rehydrated with buffer solution. From the fluorescence intensity data in FIG. 6 panel i and iii, it was calculated that only ˜40% of the immobilized chol-DNA was lost after storage in air.

Hybridization of Complementary DNA to ssDNA Bound to SU-8

We used two different techniques to verify hybridization. First hybridization was shown by fluorescence resonance energy transfer (FRET) imaging (see FIG. 6) between the fluorescently labeled DNA3 and its complementary c-DNA3/4. In FIG. 6, the right panels show the emission of the acceptor whereas the left panels show the emission of the donor, both being excited at donor excitation wavelength. Prior to adding the complementary c-DNA3/4, the fluorescence micrograph shows the immobilized DNA3 on SU-8 after the chip was kept dry for 6 hours (FIG. 6i). By comparing FIGS. 6ii, and 6iv, addition of the c-DNA3/4 increases the fluorescence signal of the Cy3-label significantly whereas it decreases for the FAM-label (compare FIGS. 6i, and 6iii). This proves FRET between the labeled couple, and thus DNA hybridization. After the chip has been rinsed, dried and rehydrated with buffer solution, the immobilized and hybridized DNA3+c-DNA3/4 pair was still present on the SU-8 surface (see FIGS. 6v, and 6vi). Hybridization was also verified by the detection of fluorescently labeled complementary DNA strands which were bound to unlabeled immobilized chol-DNA (see FIG. 7). As mentioned above, oligonucleotides lacking a cholesteryl moiety do not adsorb on SU-8 surfaces. We used the DNA4+c-DNA3/4 as well as the DNA2+c-DNA1/2 pairs and Fluorescence recovery after photobleaching (FRAP) was monitored. The immobilized DNA (DNA4 and DNA2) were not labeled and evidence of hybridization comes from detection of fluorescence from Cy3 in the complementary strands (c-DNA3/4 and c-DNA1/2). Using high laser light intensity, a defined region of interest was bleached and the fluorescence recovery of the bleached spot was monitored. The kinetics of the exchange of bleached and un-bleached double-stranded oligonucleotides (dsDNA) from the solution to the substrate is yet to be determined but as the dsDNA-chip system equilibrates, the shorter oligonucleotides shows faster desorption/adsorption behavior compared to the longer oligonucleotides. However, the bleached spot was never fully recovered within the experimental time frame. In conclusion, the results from the hybridization experiment prove that cholesteryl-TEG-modified oligonucleotides are accessible to their complementary strands, even after the immobilized DNA has been kept dry for several hours.

Presented herein are straightforward one-step processes for immobilizing cholesteryl-modified oligonucleotides on hardbaked SU-8 surfaces. The attachment between the substrate and the DNA is presumably based on the hydrophobic nature of the SU-8 and the cholesteryl-TEG modification at the 5′ or 3′ position of the oligonucleotide. The immobilized DNA on SU-8 shows robust and efficient attachment, high surface coverage, and is accessible to hybridization by complementary strands. Previous surface coverage values for DNA immobilization by covalent attachment are in the range of 10¹¹-10¹² molecules/cm². Here we achieve a ten times higher surface coverage in a simple one-step immobilization protocol. Furthermore, the immobilized chol-DNA is still functional after being kept dry for several hours.

1. A device comprising a substrate comprising a hydrophobic surface, wherein the hydrophobic surface is adapted for oriented association or attachment and/or oriented spreading of molecules having at least one hydrophobic part.

2. The device of claim 1, wherein the hydrophobic surface comprises or forms all or a part of a chamber, column, 2-dimensional surface, Quartz Crystal Microbalance (QCM) crystals, Surface Plasmon Resonance (SPR), chip, microscope cover slip, microfluidic chip, sandwich cell, or channel.

3. The device of claim 1, wherein the hydrophobic surface comprises one or more of SU-8, hard-baked SU-8, hydrophobic polymer, glass, ceramic, metal, or liquid crystal.

4. The device of claim 1, wherein the hydrophobic surface comprises a pattern of substructures.

5. The device of claim 4, wherein the substructures comprise one or more of perforations in the layer, wells in the layer, pillars or other materials on the layer, patches, or immobilized particles, films, chemicals, or molecules.

6. The device of claim 5, wherein the perforations in the layer, wells in the layer, pillars or other materials on the layer, patches, or immobilized particles, films, chemicals, or molecules comprise a catalytic, binding, chemisorptive, physiosorptive, or modulatory effect on materials or compounds present in the thin film, a surrounding solution and/or surrounding air, gas, or vacuum.

7. The device of claim 4, wherein the substructures are arranged in one or more of an ordered (e.g., arrayed) or unordered manner, and are adapted to be either fully or partially covered, or to be surrounded by a spreading film of molecules having at least one hydrophobic part.

8. The device of claim 4, wherein the hydrophobic surface is adapted for processes comprising chemical reactions, surface-assisted synthetic procedures, catalytic processes, supramolecular self-assembly, or affinity-based separation.

9. The device of claim 1, wherein the molecules having at least one hydrophobic part comprise one or more of phospholipids, amphiphilic molecules, surfactants, proteins, peptides, nucleic acid, oligonucleotides, molecules modified with hydrophobic moieties.

10. The device of claim 1, wherein the molecules having at least one hydrophobic part comprise a film.

11. The device of claim 10, wherein the film comprises one or more of a liquid, solid, liquid crystal, or gel.

12. The device of claim 1, further comprising a temperature controller.

13. The device of claim 12, wherein the temperature controller allows control over phase transitions and spreading behavior of molecules or molecular aggregates such as, for example, thin films, having at least one hydrophobic part are controllable.

14. The device of claim 1, wherein the hydrophobic surface comprises one or more of an embossed or imprinted geometric pattern.

15. (canceled)

16. A device comprising a substrate comprising a hydrophobic surface having a thin-film monolayer surface formed in a polar environment associated therewith, wherein the thin-film monolayer surface is formed by placing a phospholipid liposome on the hydrophobic surface, wherein the phospholipid liposome spreads to form the thin-film monolayer surface when place on the hydrophobic surface.

17. The device of claim 16, wherein the thin-film monolayer further comprises one or more additional components.

18. The device of claim 17, wherein the further components comprise one or more of other lipids, membrane proteins, molecules or particles that are adapted to partition into membranes, or molecules and particles that are conjugated to another molecule that are adapted to partition into membranes.

19. The device of claim 17, wherein the one or more additional components comprise an oligonucleotide conjugated with a hydrophobic moiety.

20. A device comprising a substrate comprising a mixer comprising a first and a second injection pod in communication with a mixing region wherein the injection pods, first and second communication regions and the mixing region comprise a hydrophobic surface adapted for oriented association or attachment and/or oriented spreading of molecules having at least one hydrophobic part.

21. The device of claim 20, wherein the substrate further comprises one or more additional injection pods in communication with the mixing region.

22. The device of claim 20, wherein the substrate further comprises a less hydrophobic surface surrounding the hydrophobic surfaces.

23. The device of claim 22, wherein the substrate comprises gold-coated glass with patterned SU-8 and Ti/Au surfaces.

24. The device of claim 20, further comprising one or more additional mixers.

25. The device of claim 20, further comprising input and waste channels in communication with the mixing region as well as channels to reactors.

26. The device of claim 20, wherein the injection port is circular, square, pentagonal, hexagonal, triangular, rectangular or any other geometric shape.

27-34. (canceled)

35. A method of mixing liposomes on a surface comprising:
placing a first liposome on a hydrophobic surface, and
placing a second liposome of a different composition on the hydrophobic surface, wherein the first and second liposomes spread and the resulting lipid films mix on the hydrophobic surface.

36-40. (canceled)

41. The method of claim 40, wherein the functional surface comprises one or more of a 2- or 3-dimensional device.

42. The method of claim 41, wherein the 2- or 3-dimensional device comprises a chamber, capillary, column or any other device of macroscopic or microscopic dimensions.

43. The method of claim 40, wherein the functional surface comprises one or more of a catalytic surface, a binding surface, or a surface supporting a physical or chemical operation.

44-64. (canceled)

65. A method of forming a nucleic acid film, comprising:
placing modified nucleic acid molecules on a hydrophobic surface of a substrate, wherein the modified nucleic acid molecules associate with the surface thereby forming a nucleic acid film.

66-76. (canceled)
